(19) United States
(12) Patent Application Publication
(10) Pub. No.: US 2024/0158567 A1
(43) Pub. Date: May 16, 2024

(54) ALL-PURPOSE POLY(3-HYDROXYBUTYRATE) BY STEREOMICROSTRUCTURAL ENGINEERING

(71) Applicant: COLORADO STATE UNIVERSITY RESEARCH FOUNDATION, Fort Collins, CO (US)

(72) Inventors: Eugene CHEN, Fort Collins, CO (US); Ethan QUINN, Fort Collins, CO (US); Zhen ZHANG, Fort Collins, CO (US)

(21) Appl. No.: 18/492,554

(22) Filed: Oct. 23, 2023

Related U.S. Application Data
(60) Provisional application No. 63/524,397, filed on Jun. 30, 2023.
(60) Provisional application No. 63/418,109, filed on Oct. 21, 2022.

(51) Int. Cl. C08G 63/06; C08L 67/04; C09J 167/04

(52) U.S. Cl. CPC C08G 63/06; C08L 67/04; C09J 167/04; C08L 2205/025

(57) ABSTRACT

Syndio-rich P3HB (sr-P3HB), readily synthesized from the eight-membered meso-dimethyl diolide, has a unique set of stereomicrostructures comprising enriched syndiotactic [rr] and no isotactic [mm] triads but abundant stereo-defects randomly distributed along the chain. This sr-P3HB material is characterized by high toughness (U_{T}=96 MJ/m³), as a result of its high elongation at break (>400%) and tensile strength (34 MPa), crystallinity (Tₘ=114° C.), and optical clarity (due to its sub-micron spherulites), and good barrier properties, while it still biodegrades in freshwater and soil. On the other hand, iso-rich P3HB (ir-P3HB) can be synthesized from the eight-membered rac-dimethyl diolide. While sr-P3HB exhibits excellent adhesion strength toward a variety of substrates, both sr-P3HB and ir-P3HB can substantially toughen brittle stereoperfect biological or synthetic P3HB. Both sr-P3HB and ir-P3HB can also be obtained from the four-membered rac-beta-butyrolactone with appropriate catalysts.

### RELATED APPLICATIONS

This application claims priority under 35 U.S.C. §119(e) to U.S. Provisional Patent Application No. 63/524,397 filed Jun. 30, 2023, and U.S. Provisional Patent Application No. 63/418,109 filed Oct. 21, 2022, which applications are incorporated herein by reference.

### GOVERNMENT SUPPORT

This invention was made with government support under grant DE-AC36-08G028308 awarded by the Department of Energy. The government has certain rights in the invention.

### BACKGROUND OF THE INVENTION

Amongst several strategies¹-16 being developed to combat the current plastics problem,¹⁷⁻²¹ bio-based and biodegradable polymers²²-25 offer a more sustainable and environmentally benign alternative to the petroleum-based and non-degradable incumbent plastics. In particular, polyhydroxyalkanoates (PHAs), a class of biopolymers that can be synthesized biologically²⁶-34 and chemocatalytically,³⁵-38 are biodegradable in ambient environments, thus attracting intense interest. Purely isotactic poly(3-hydroxybutyrate) (sp-P3HB), also known as stereoperfect poly(3-hydroxybutyrate) (sp-P3HB), the most commonly produced PHA, exhibits several favorable properties including high crystallinity, melting-transition temperature (Tₘ, 170-180° C.), and ultimate tensile strength (σ_{B}=˜35 MPa), as well as excellent barrier properties. However, its perfect stereoregularity and thus high crystallinity brings about its extreme brittleness, with elongation at break (ε_{B})˜3-6%, which largely limits its broader applications, especially in packaging.^{39, 40}

Biological routes produce isotactic (R)-polymers or copolymers of largely random sequences with dispersity (Ð)>2 due to the step-growth polymerization mechanism.^{26, 29-32, 35} Chemical synthesis of PHAs that operates on the catalyzed ring-opening polymerization (ROP) proceeds via a rapid chain-growth mechanism, which comes with advantages of faster reaction kinetics and precision control over both the PHA chain structures (predictable number-average molar mass (Me) and low to near unity Ð values) and stereomicrostructures (tacticities). 36 For example, the ROP of [symbol] -butyrolactone ( [symbol] -BL) produces diverse P3HB materials that are atactic (at),⁴¹⁻⁵⁰ iso-rich (1r),⁵¹-59 and syndiotactic (st) or syndio-rich (sr).⁶⁰-65 The ROP of racemic eight-membered dimethyl diolide (rac-8DL^{Me}) catalyzed by C₂-chrial salen-based metal complexes results in biomimetic sp-P3HB.⁶⁶ This platform based on the diolides having two stereogenic centers was extended to afford stereo-sequenced stereoblock P3HB and other PHAs⁶⁷ including alternating isotactic PHAs,⁶⁸ both with enhanced ductility. Another method to toughen P3HB is through copolymerization of rac-8DL^{Me} with rac-8DL^{R} with longer alkyl pendant groups (R=Et, nBu), which created tough, polyolefin-like thermoplastics.^{67,69} The copolymerization of rac-8DL^{Me} has extended to other lactones, yielding toughened P3HB.^{70,71}

Despite these advances, there is a need for biodegradable alternatives to semicrystalline isotactic polypropylene, such as a P3HB composition with enhanced toughness and optical clarity, while still possessing crystallinity and biodegradability.

### SUMMARY

The invention provides a polymer comprising a syndio-rich poly(3-hydroxyalkanoate) of formula I, or an iso-rich poly(3-hydroxyalkanoate) of formula II:

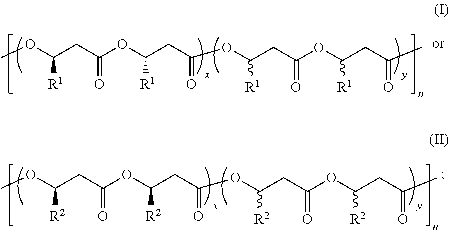

wherein,

R¹ are each (C₁-C₁₈)alkyl, (C₁-C₈)alkenyl, (C₁-C₈)alkynyl, benzyl, or aryl; or

R² are each (C₁-C₁₈)alkyl, (C₁-C₈)alkenyl, (C₁-C₈)alkynyl, benzyl, or aryl;

x are syndiotactic triads (rr) in the polymer of formula I, wherein the syndiotactic triads have at least 95% alternating (R) and (S) stereochemical configurations with respect to the stereocenters of substituents R¹ on the polymer chain;

y are heterotactic triads (mr or rm) in the polymer of formula I, wherein the heterotactic triads have random stereochemical configurations with respect to the stereocenters of substituents R¹ on the polymer chain;

wherein repeat units of y are randomly distributed between repeat units of x throughout the polymer chain; or
x are isotactic triads (mm) in the polymer formula II, wherein the isotactic triads have at least 95% consecutive (R) stereochemical configurations or 95% consecutive (S) stereochemical configurations with respect to the stereocenters of substituents R² on the polymer chain;
y are heterotactic triads (mr or rm) in the polymer of formula II, wherein the heterotactic triads have random stereochemical configurations with respect to the stereocenters of substituents R² on the polymer chain;
wherein repeat units of y are randomly distributed between repeat units of x throughout the polymer chain; and

n is about 10 to about 5,000.

### BRIEF DESCRIPTION OF THE DRAWINGS

The following drawings form part of the specification and are included to further demonstrate certain embodiments or various aspects of the invention. In some instances, embodiments of the invention can be best understood by referring to the accompanying drawings in combination with the detailed description presented herein. The description and accompanying drawings may highlight a certain specific example, or a certain aspect of the invention. However, one skilled in the art will understand that portions of the example or aspect may be used in combination with other examples or aspects of the invention.

FIG. 1A-G. (A) Overall reaction scheme for the synthesis of sr-P3HB. (B) Highlighted key steps of monomer coordination, migratory insertion, and ring opening proposed in the coordination-insertion ROP of meso-8DL^{Me} using the La catalyst. (C) Listed all possible stereochemical outcomes from the metal-catalyzed ROP of meso-8DL^{Me} towards sr-P3HB, specifically showing the impossibility of generating [mm] triads (in the absence of other side reactions). (D) Semi-quantitative ¹³C NMR spectrum (CDCl₃, 23° C.) of sr-P3HB (Mₙ=171 kDa, Ð=1.07) in the carbonyl, methylene, and methyl regions. (E) ¹H NMR spectrum (CDCl₃, 23° C.) of sr-P3HB prepared with a ratio of 5,000:1:3 of meso-8DL^{Me}:La[N(SiMe₃)₂]₃: Ph₂CHOH (Mₙ=171 kDa, Ð=1.07). (F) ¹³C NMR spectrum (CDCl₃, 23° C.) of sr-P3HB prepared with a ratio of 5,000:1:3 of meso-8DL^{Me}:La[N(SiMe₃)₂]₃: Ph₂CHOH (Mₙ=171 kDa, Ð=1.07). (G) ¹³C NMR spectrum (CDCl₃, 23° C.) of (a) sr-P3HB prepared with a ratio of 5,000:1:3 of meso-8DL^{Me}:La[N(SiMe₃)₂]₃:Ph₂CHOH (Mₙ=146 kDa, Ð=1.09) and (b) it-P3HB prepared with a ratio of 800:1:1 of rac-8DL^{Me}:[cat]:BnOH in the carbonyl and methylene regions, showing the absence of [mm] triad peaks in sr-P3HB (note that [mm] triads appear at 169.27 and 40.93 ppm for the respective region).

FIG. 2A-C. (A) Differential scanning calorimetry (DSC) curves of sr-P3HB (Mₙ=171 kDa, Ð=1.07). (B) Thermogravimetric analysis (TGA) and derivative thermogravimetry (DTG) curves of sr-P3HB. (C) Thin lines: DSC second heating curves at 20° C./min of sr-P3HB (second curve from bottom) and it-P3HB⁷⁸ (uppermost curve); thick lines: final DSC heating scans after the SSA protocol for sr-P3HB (bottom curve) and it-P3HB (near middle of y-axis).

FIG. 3. (A) Stress-strain curve overlays of sr-P3HB with commercialized commodity plastics including it-PP, HDPE, PBAT, and LDPE. Strain rate: 5.0 mm/min, ambient temperature.

FIG. 4. Transmittance overlays of sr-P3HB, PMMA, Ziploc® bag, and it-P3HB.

FIG. 5. (A) Relative freshwater biodegradation results of sr-P3HB compared with synthetic (R)-P3HB, bio-P3HB, and glucose (control), 25° C. (B) Relative soil biodegradation results of sr-P3HB compared with synthetic (R)-P3HB, bio-P3HB, and microcrystalline cellulose (MCC, control).

FIG. 6. Stress-strain curves (triplicates) of sr-P3HB prepared with meso-8DL^{Me}:La[N(SiMe₃)₂]₃: P₂CHOH=5000:1:3 (Mₙ=171 kDa, Ð=1.07).

FIG. 7. Transmittance and reflectance spectra of sr-P3HB prepared with meso-8DL^{Me}: La[N(SiMe₃)₂]₃: P₂CHOH=5000:1:3 (Mₙ=171 kDa, Ð=1.07).

FIG. 8. Scheme of steps necessary to perform the SSA thermal fraction, according to one embodiment.

FIG. 9. Adhesive strength of it-P3HB (Table 1.1, Entry 4) on glass substrates from lap-shear test.

FIG. 10. Adhesive strength of sr-P3HB_{[xx]} on aluminum substrate from lap-shear testing.

FIG. 11. Adhesive strength comparison of commercial EVA hot melt and sr-P3HB_{[42]} on various substrates.

FIG. 12. Adhesive strength of commercial glues and sr-P3HBs obtained from single lap-shear tests on aluminum substrates.

FIG. 13. The chemical structures of employed monomers and catalysts for the synthesis of P3HB from β-butyrolactone (BBL).

FIG. 14. Adhesive strength of at- and sr-P3HBs synthesized from BBL.

FIG. 15. Stress-strain curves of commercial EVA hot melt. Strain rate=5 mm min⁻¹, ambient condition.

FIG. 16. Stress-strain curves of sr-P3HB_{[42]} (Mₙ=260 kDa, Ð=1.24). Strain rate=5 mm min⁻¹, ambient condition.

FIG. 17. (A) Overlay of DSC traces (10° C. min⁻¹, 2^{nd} heating scan) of sp-P3HB_{b} (Table 2.1, Entry 1), it-P3HB (Table 2.1, Entry 3), ir-P3HB₇₈₈ₖ (Table 2.1, Entry 5; 1^{st} heating scan), and b1_{sp(b)ir} (blend of sp-P3HB_{b} and ir-P3HB₇₈₈ₖ in a weight ratio of 70:30). (B) Final DSC heating scans after the SSA protocol for sp-P3HB_{b}, ir-P3HB₇₈₈ₖ, and b1_{sp(b)ir}. (C) SEM images of the cross-section (3 kV, 10 nm Au coating) of b1_{sp(b)/ir}.

FIG. 18. Stress-strain curves of: (A) sp-P3HBₛ (Table 2.1, Entry 2), it-P3HB (Table 2.1, Entry 3), ir-P3HB₁₀₆ₖ (Table 2.1, Entry 4), ir-P3HB₇₈₈ₖ (Table 2.1, Entry 5), ir-P3HB_{BBL} (Table 2.1, Entry 6) and sr-P3HB (Table 2.1, Entry 7); (B) Physical blends of sp-P3HBₛ and ir-P3HB₇₈₈ₖ in weight ratios of 90:10, 70:30, 50:50, 30:70 and 10:90; and (C) sp-P3HB_{b}, blends (70:30 wt. ratio) of sp-P3HB_{b} and ir-P3HB_{BBL} (b1_{sp(b)in(BBL)}), sp-P3HB_{b} and ir-P3HB₇₈₈ₖ (b1_{sp(b)/ir}), sp-P3HB_{b} and sr-P3HB (b1_{sp(b)/sr}) and sp-P3HB_{b} and at-P3HB (b1_{sp(b)/at}). Strain rate=5 mm ambient condition.

FIG. 19. Overlay of ¹³C{¹H} NMR (CDCl₃, 23° C.) spectra of ir-P3HB₇₈₈ₖ and ir-P3HB_{BBL} in the carbonyl, methylene, and methyl regions produced from rac-8DL^{Me} and rac-BBL, respectively.

FIG. 20. 1^{st} heating and cooling DSC scans of b1_{sp(b)/ir}. Scan rate: 10° C.

FIG. 21. DSC traces of b1_{sp(s)/ir} in various weight ratios: (A) second heating scans and (B) first cooling scans. Scan rate: 10° C.

FIG. 22. DSC traces of b1_{sp(s)/ir} (A) as prepared and (B) after annealing at ˜25° C. for 24 h. Scan rate: 10° C.

FIG. 23. DSC traces of b1_{sp(b)/ir} (A) as prepared and (B) after annealing at ˜25° C. for 24 h. Scan rate: 10° C.

FIG. 24. SEM images of b1_{sp(s)/ir} with various sp-P3HBₛ:ir-P3HB₇₈₈ₖ weight ratios.

FIG. 25. Transmittance overlays of PMMA (red), ir-P3HB₇₈₈ₖ (blue), LDPE Ziploc Bag (green), and sp-P3HBₛ (black).

FIG. 26. Stress-strain curves of the blend of sp-P3HB_{b} and ir-P3HB₁₇₇ₖ(Mₙ=177 kDa, Ð=1.04) (weight ratio=70:30). Strain rate=5 mm min⁻¹, ambient condition.

FIG. 27. Stress-strain curves of b1_{sp(b)/ir} with a weight ratio of 70:30. Strain rate=5 mm min⁻¹, ambient condition.

FIG. 28. Stress-strain curves of b1_{sp(b)/sr} with a weight ratio of 70:30. Strain rate=5 mm min⁻¹, ambient condition.

FIG. 29. Stress-strain curves of b1_{sp(b)/sr} after annealing at ˜25° C. for 12 h. Strain rate=mm min⁻¹, ambient condition.

FIG. 30. Stress-strain curves of ir-P3HB₁₀₆ₖ (Mₙ=106 kDa, Ð=1.04) prepared with catalyst 4 after annealing at ˜25° C. for 24 h. Strain rate=5 mm min⁻¹, ambient condition.

FIG. 31. Stress-strain curves of ir-P3HB₇₈₈ₖ (Mₙ=788 kDa, Ð=1.19) produced by catalyst 4 after annealing at 25° C. for ˜24 h. Strain rate=5 mm min⁻¹, ambient condition.

FIG. 32. Stress-strain curves of sr-P3HB (Mₙ=260 kDa, Ð=1.24) prepared with catalyst 3. Strain rate=5 mm min⁻¹, ambient condition.

FIG. 33. Stress-strain curves of b1_{sp(b)/ir(BBL)} with a weight ratio of 70:30. ir-P3HB_{BBL}: Mₙ=227 kDa, Ð=1.83. Strain rate=5 mm min⁻¹, ambient condition.

FIG. 34. Stress-strain curves of b1_{sp(b)/at} with a weight ratio of 70:30. Strain rate=5 mm min⁻¹, ambient condition.

FIG. 35. ¹³C {¹H} NMR (CDCl₃, 23° C.) spectrum of ir-P3HB₇₈₈ₖ produced by catalyst 4.

### DETAILED DESCRIPTION

Stereo-defects present in stereoregular polymers often diminish thermal and mechanical properties. Suppressing or eliminating stereo-defects is therefore a major aspirational goal of achieving polymers with optimal or enhanced properties. Here, we accomplish the opposite: by introducing controlled stereo-defects to semicrystalline biodegradable poly(3-hydroxybutyrate) (P3HB), which offers an attractive biodegradable alternative to semicrystalline isotactic polypropylene but is brittle and opaque, we enhance specific properties and mechanical performance of P3HB by drastically toughening it and also rendering it with the desired optical clarity, while maintaining its biodegradability and crystallinity.

This toughening strategy of stereomicrostructural engineering without changing chemical compositions also departs from the conventional approach of toughening P3HB through copolymerization that increases chemical complexity, suppresses crystallization in the resulting copolymers, and is thus undesirable in the context of polymer recycling and performance. More specifically, syndio-rich P3HB (sr-P3HB), readily synthesized from the eight-membered meso-dimethyl diolide (meso-8DL^{Me}), has a unique set of stereomicrostructures comprising enriched syndiotactic [rr] and no isotactic [mm] triads but abundant stereo-defects randomly distributed along the chain. This sr-P3HB material is characterized by high toughness (U_{T}=96 MJ/m³) as a result of its high elongation at break (>400%) and tensile strength (34 MPa), crystallinity (Tₘ=114° C.), optical clarity (due to its sub-micron spherulites), and good barrier properties, while still being biodegradable in freshwater and soil.

### Definitions.

The following definitions are included to provide a clear and consistent understanding of the specification and claims. As used herein, the recited terms have the following meanings. All other terms and phrases used in this specification have their ordinary meanings as one of skill in the art would understand. Such ordinary meanings may be obtained by reference to technical dictionaries, such as Hawley's Condensed Chemical Dictionary 14^{th} Edition, by R. J. Lewis, John Wiley & Sons, New York, N.Y., 2001.

References in the specification to “one embodiment”, “an embodiment”, etc., indicate that the embodiment described may include a particular aspect, feature, structure, moiety, or characteristic, but not every embodiment necessarily includes that aspect, feature, structure, moiety, or characteristic. Moreover, such phrases may, but do not necessarily, refer to the same embodiment referred to in other portions of the specification. Further, when a particular aspect, feature, structure, moiety, or characteristic is described in connection with an embodiment, it is within the knowledge of one skilled in the art to affect or connect such aspect, feature, structure, moiety, or characteristic with other embodiments, whether or not explicitly described.

The singular forms “a,” “an,” and “the” include plural reference unless the context clearly dictates otherwise. Thus, for example, a reference to “a compound” includes a plurality of such compounds, so that a compound X includes a plurality of compounds X. It is further noted that the claims may be drafted to exclude any optional element. As such, this statement is intended to serve as antecedent basis for the use of exclusive terminology, such as “solely,” “only,” and the like, in connection with any element described herein, and/or the recitation of claim elements or use of “negative” limitations.

The term “and/or” means any one of the items, any combination of the items, or all of the items with which this term is associated. The phrases “one or more” and “at least one” are readily understood by one of skill in the art, particularly when read in context of its usage. For example, the phrase can mean one, two, three, four, five, six, ten, 100, or any upper limit approximately 10, 30 100, or 1000 times higher than a recited lower limit. For example, one or more substituents on a phenyl ring refers to one to five, or one to four, for example if the phenyl ring is disubstituted.

As will be understood by the skilled artisan, all numbers, including those expressing quantities of ingredients, properties such as molecular weight, reaction conditions, and so forth, are approximations and are understood as being optionally modified in all instances by the term “about.” These values can vary depending upon the desired properties sought to be obtained by those skilled in the art utilizing the teachings of the descriptions herein. It is also understood that such values inherently contain variability necessarily resulting from the standard deviations found in their respective testing measurements. When values are expressed as approximations, by use of the antecedent “about,” it will be understood that the particular value without the modifier “about” also forms a further aspect.

The term “about” can refer to a variation of ±5%, ±10%, ±20%, or ±25% of the value specified. For example, “about 50” percent can in some embodiments carry a variation from 45 to 55 percent, or as otherwise defined by a particular claim. For integer ranges, the term “about” can include one or two integers greater than and/or less than a recited integer at each end of the range. Unless indicated otherwise herein, the term “about” is intended to include values, e.g., weight percentages, proximate to the recited range that are equivalent in terms of the functionality of the individual ingredient, composition, or embodiment. The term about can also modify the endpoints of a recited range as discussed above in this paragraph.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. It is therefore understood that each unit between two particular units is also disclosed. For example, if 10 to 15 is disclosed, then 11, 12, 13, and 14 are also disclosed, individually, and as part of a range. A recited range (e.g., of weight percentages, carbon groups, or monomeric units) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc. For example, blocks of the formulas of polymers described herein (e.g., n of formula I or formula II) that are about 10 to about 5,000 can be about 10 to about 4,000, about 10 to about 3,000, about 10 to about 2,000, about 10 to about 1,000, about 10 to about 500, about 10 to about 50, about 100 to about 5,000, about 100 to about 2,500, about 100 to about 1,000, about 100 to about 500, about 50 to about 5,000, or about 50 to about 1,000, and in various embodiments, the blocks of the formulas of polymers described herein can be about to about 60, about 30 to about 50, about 40 to about 90, about 40 to about 85, about 35 to about 45, about 45 to about 55, about 60 to about 70, about 70 to about 80, about 75 to about 85, or about 75 to about 100, or a range in between any two of the aforementioned integers.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents. It will be further understood that the endpoints of each of the ranges are significant both in relation to the other endpoint, and independently of the other endpoint.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, for use in an explicit negative limitation.

The term “contacting” refers to the act of touching, making contact, or of bringing to immediate or close proximity, including at the cellular or molecular level, for example, to bring about a physiological reaction, a chemical reaction, or a physical change, e.g., in a solution, in a reaction mixture, in vitro, or in vivo.

The term an “effective amount” refers to an amount effective to bring about a recited effect, such as an amount necessary to form products in a reaction mixture. Determination of an effective amount is typically within the capacity of persons skilled in the art, especially in light of the detailed disclosure provided herein. The term “effective amount” is intended to include an amount of a compound or reagent described herein, or an amount of a combination of compounds or reagents described herein, e.g., that is effective to form products in a reaction mixture. Thus, an “effective amount” generally means an amount that provides the desired effect.

The term “alkyl” refers to a branched or unbranched hydrocarbon having, for example, from 1-20 carbon atoms, and often 1-12, 1-10, 1-8, 1-6, or 1-4 carbon atoms. Examples include, but are not limited to, methyl, ethyl, 1-propyl, 2-propyl (iso-propyl), 1-butyl, 2-methyl-1-propyl (isobutyl), 2-butyl (sec-butyl), 2-methyl-2-propyl (t-butyl), 1-pentyl, 2-pentyl, 3-pentyl, 2-methyl-2-butyl, 3-methyl-2-butyl, 3-methyl-1-butyl, 2-methyl-1-butyl, 1-hexyl, 2-hexyl, 3-hexyl, 2-methyl-2-pentyl, 3-methyl-2-pentyl, 4-methyl-2-pentyl, 3-methyl-3-pentyl, 2-methyl-3-pentyl, 2,3-dimethyl-2-butyl, 3,3-dimethyl-2-butyl, hexyl, octyl, decyl, dodecyl, and the like. The alkyl can be unsubstituted or substituted, for example, with a substituent described below. The alkyl can also be optionally partially or fully unsaturated. As such, the recitation of an alkyl group can include (when specifically stated) alkenyl or alkynyl groups. The alkyl can be a monovalent hydrocarbon radical, as described and exemplified above, or it can be a divalent hydrocarbon radical (i.e., an alkylene).

The term “aryl” refers to an aromatic hydrocarbon group derived from the removal of at least one hydrogen atom from a single carbon atom of a parent aromatic ring system. The radical attachment site can be at a saturated or unsaturated carbon atom of the parent ring system. The aryl group can have from 6 to 20 carbon atoms, for example, about 6 to about 10 carbon atoms. The aryl group can have a single ring (e.g., phenyl) or multiple condensed (fused) rings, wherein at least one ring is aromatic (e.g., naphthyl, dihydrophenanthrenyl, fluorenyl, or anthryl). Typical aryl groups include, but are not limited to, radicals derived from benzene, naphthalene, anthracene, biphenyl, and the like. The aryl can be unsubstituted or optionally substituted, as described for alkyl groups.

The term “substituted” indicates that one or more hydrogen atoms on the group indicated in the expression using “substituted” or “optionally substituted” is replaced with a “substituent”. The number referred to by ‘one or more’ can be apparent from the moiety on which the substituents reside. For example, one or more can refer to, e.g., 1, 2, 3, 4, 5, or 6; in some embodiments 1, 2, or 3; and in other embodiments 1 or 2, and if the substituent is an oxo group, two hydrogen atoms are replaced by the presence of the substituent. The substituent can be one of a selection of indicated groups, or it can be a suitable group recited below or known to those of skill in the art, provided that the substituted atom's normal valency is not exceeded, and that the substitution results in a stable compound. Suitable substituent groups include, e.g., alkyl, alkenyl, alkynyl, alkoxy, halo, haloalkyl, hydroxy, hydroxyalkyl, aryl, aroyl, (aryl)alkyl (e.g., benzyl or phenyl ethyl), heteroaryl, heterocycle, cycloalkyl, alkanoyl, alkoxycarbonyl, alkylcarbonyloxy, amino, alkylamino, dialkylamino, trifluoromethyl, trifluoromethoxy, trifluoromethylthio, difluoromethyl, acylamino, nitro, carboxy, carboxyalkyl, keto, thioxo, alkylthio, alkylsulfinyl, alkylsulfonyl, arylsulfinyl, arylsulfonyl, heteroarylsulfinyl, heteroarylsulfonyl, heterocyclesulfinyl, heterocyclesulfonyl, phosphate, sulfate, hydroxyl amine, hydroxyl (alkyl)amine, and cyano, as well as the moieties illustrated in the schemes and priority documents of this disclosure, and combinations thereof. Additionally, suitable substituent groups can be, e.g., —X, —R, —O⁻, —OR, —SR, —S⁻, —NR₂, —NR₃, ═NR, —CX₃, —CN, —OCN, —SCN, —N═C═O, —NCS, —NO, —NO₂, ═N₂, —N₃, —NC(═O)R, —C(═O)R, —C(═O)NRR, —S(═O)₂O⁻, —S(═O)₂H, —S(═O)₂R, —OS(═O)₂OR, —S(═O)₂NR, —S(═O)R, —OP(═O)(OR)₂, —P(═O)(OR)2, —OP(═O)(OH)(OR), —P(═O)(OH)(OR), —P(═O)(O⁻)₂, —P(═O)(OH)₂, —C(═O)R, —C(═O)X, —C(S)R, —C(O)OR, —C(O)O⁻, —C(S)OR, —C(O)SR, —C(S)SR, —C(O)NRR, —C(S)NRR, or —C(NR)NRR, where each X is independently a halogen (“halo”): F, Cl, Br, or I; and each R is independently H, alkyl, aryl, (aryl)alkyl (e.g., benzyl), heteroaryl, (heteroaryl)alkyl, heterocycle, heterocycle(alkyl), or a protecting group. As would be readily understood by one skilled in the art, when a substituent is keto (═O) or thioxo (=S), or the like, then two hydrogen atoms on the substituted atom are replaced. In some embodiments, one or more of the substituents above can be excluded from the group of potential values for substituents on the substituted group. The various R groups in the schemes of this disclosure can be one or more of the substituents recited above, thus the listing of certain variables for such R groups (including R¹, R², R³, etc.) are representative and not exhaustive, and can be supplemented with one or more of the substituents above. For example, a substituted alkyl can be an aryl-substituted alkyl, for example, benzyl (—Bn).

The term “alcohol” refers to an at least mono-hydroxy-substituted alkane. A typical alcohol comprises a (C₁-C₁₂)alkyl moiety substituted at a hydrogen atom with one or more hydroxyl group. Alcohols include methanol, ethanol, n-propanol, i-propanol, n-butanol, i-butanol, s-butanol, t-butanol, n-pentanol, i-pentanol, hexanol, cyclohexanol, heptanol, octanol, nonanol, decanol, benzyl alcohol, phenylethanol, diphenylmethanol, triphenylmethanol, and the like. The carbon atom chain in alcohols can be straight, branched, cyclic, or aryl. Alcohols can be mono-hydroxy, di-hydroxy, tri-hydroxy, and the like (e.g., saccharides), as would be readily recognized by one of skill in the art.

The variables and limitations described for one general or specific embodiment for any polymer described herein can also be applied to other embodiments, for example, other variations of a polymer or formula described herein, and variations of the embodiments provided in the description and Examples herein.

The polymers described herein can be polymers of a single type of monomer, or polymers of more than one type of monomer. The polymers can be random polymers, or copolymers that include portions of the random polymers described herein, in combination with other polymers. In various embodiments, the polymers described herein can be combined with a polymer as described by U.S. Pat. No. 10,954,335 (Chen et al.), which includes examples of block copolymers such as stereodiblock copolymers, stereotapered copolymers, stereogradient copolymers, stereorandom copolymers, or stereoalternating copolymers, for example, as schematically illustrated below, showing actual or approximate location and/or organization of monomers as a result of synthetic preparation.

The term “stereodiblock” as used herein refers to a polymer and/or polymeric structure comprising an at least two polymeric blocks wherein each block has a stereoregularity unique to the block. This can be understood to mean, by way of example, a polymer of repeating units AAA-BBB where a first (A) block has either a stereoregular R or S configuration such that essentially all of the A block is of such configuration, and a second (B) block having a stereoregular configuration such that essentially all of the B block is the opposite configuration as to the A block.

The term “essentially perfect” as used herein to describe isotacticity refers to an isotactic polymer wherein no stereo-irregularities can be identified through standard NMR analysis.

The term “enantiomeric excess” (e.e.) refers to a measurement of the purity of a chiral substance and can be expressed as a percent of a major enantiomer present minus the percent of a minor enantiomer present wherein the enantiomeric excess of a single pure enantiomer such as where a chiral substance is all R or all S possesses an enantiomeric excess of 1.0, understood to be 100%, and would be considered optically pure.

The term “enantiopure” as used herein refers to a compound or sample of polymers wherein the chiral centers within the molecule are all of the same chirality, as determined by NMR analysis or chiral HPLC.

Poly(3-hydroxybutyrate) by Stereomicrostructural Engineering.

Although the copolymerization strategy employed in the biological and chemical routes effectively toughens P3HB, increasing chemical complexity and suppressing crystallization in the form of copolymers is undesirable in the context of polymer recycling and performance. Considering the emerging needs for the mono-material product design and the fact that tacticity has been shown to have dramatic effects on the physical properties of polymers,^{10,72} engineering stereomicrostructures of polymers to achieve desired target properties without changing chemical composition should be a more sustainable strategy. In this context, through regulating tacticities (the range of isotactic [mm], syndiotactic [rr], and heterotactic [mr] distributions) by employing the ROP of a mixture of racemic (R,S) [symbol] -BL and enantiopure (R)- [symbol] -BL at different ratios, Doi et al. showed the mechanical properties of P3HB can be largely tuned from high Tₘ (177° C.) it-P3HB that is hard, rigid, strong but brittle to low Tₘ (52, 62° C.) sr-P3HB [Pᵣ (the probability of racemic linkages between two consecutive monomer units)=0.70] that is soft (elastic modulus E=20 MPa) and weak (σ_{B}=13 MPa) but ductile.⁷³ Mehrkhodavandi et al.⁶⁴ reported the ROP of rac-(R,S)- [symbol] -BL by a chiral zinc catalyst afforded melt-processable sr-P3HB (Pᵣ=0.64) that is strong, ductile, and tough, but its low Tₘ (46, 66° C.) would limit its application. In comparison, at-P3HB is a soft (E=7 MPa), flexible (ε_{B}=380%), and weak (σ_{B}=6.5 MPa) elastomer.⁶⁴

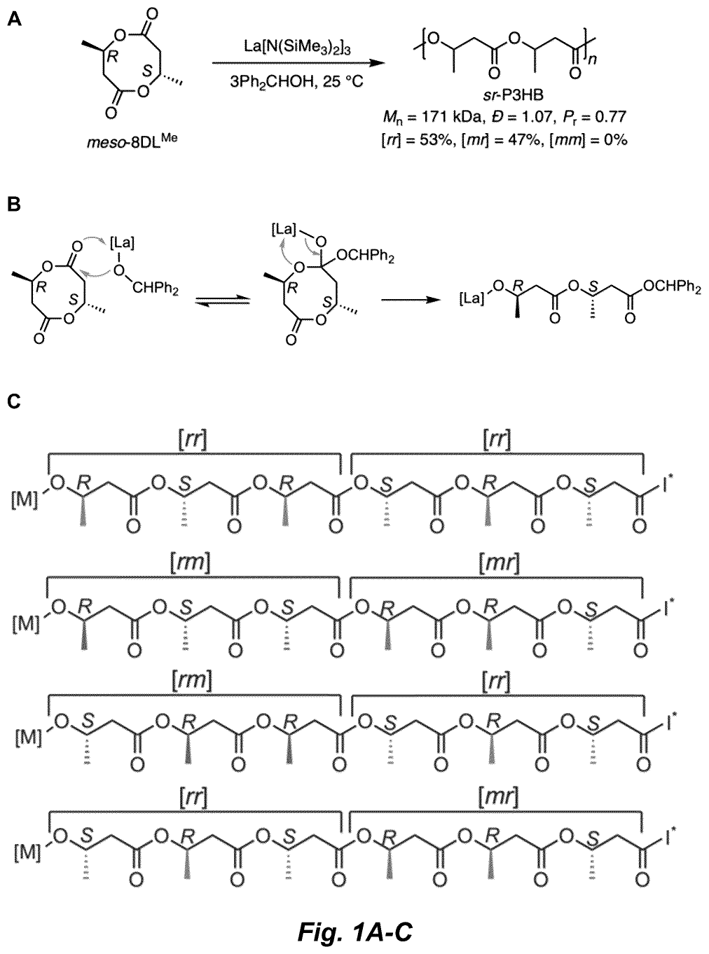

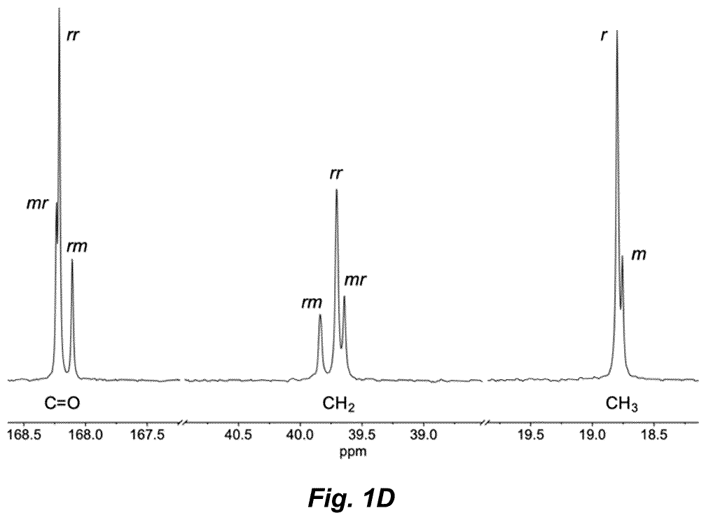

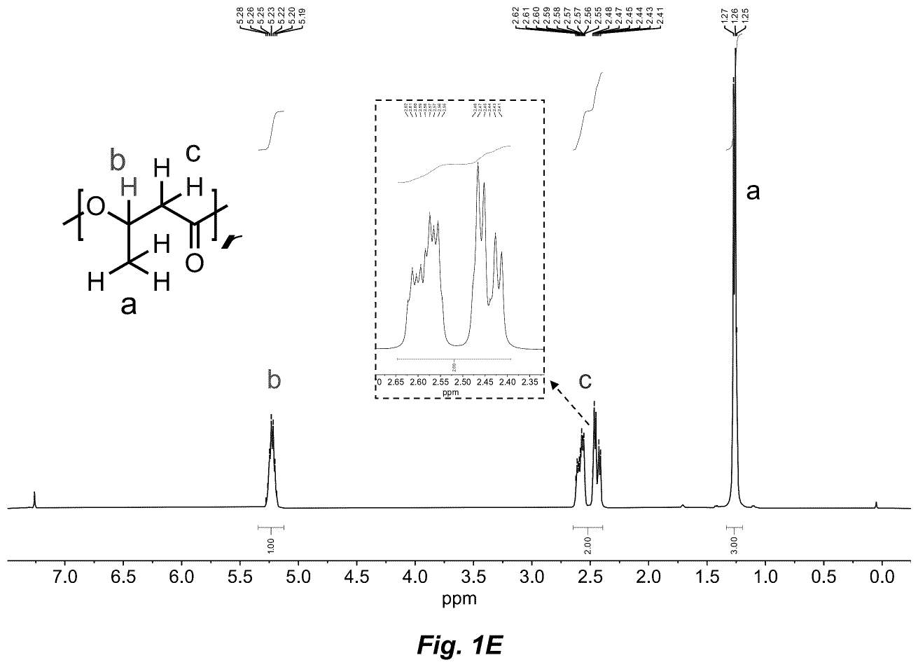

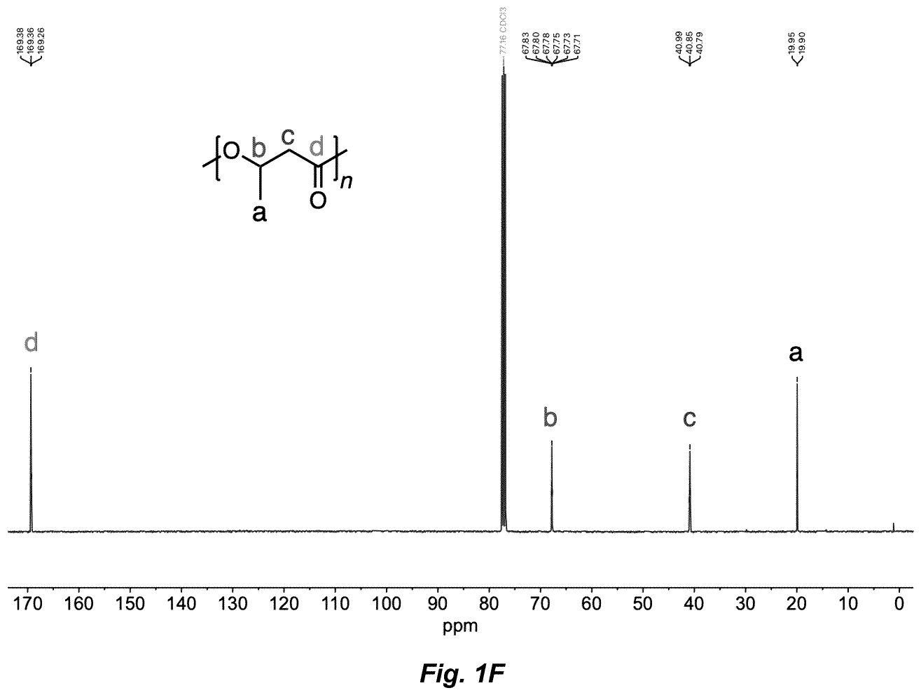

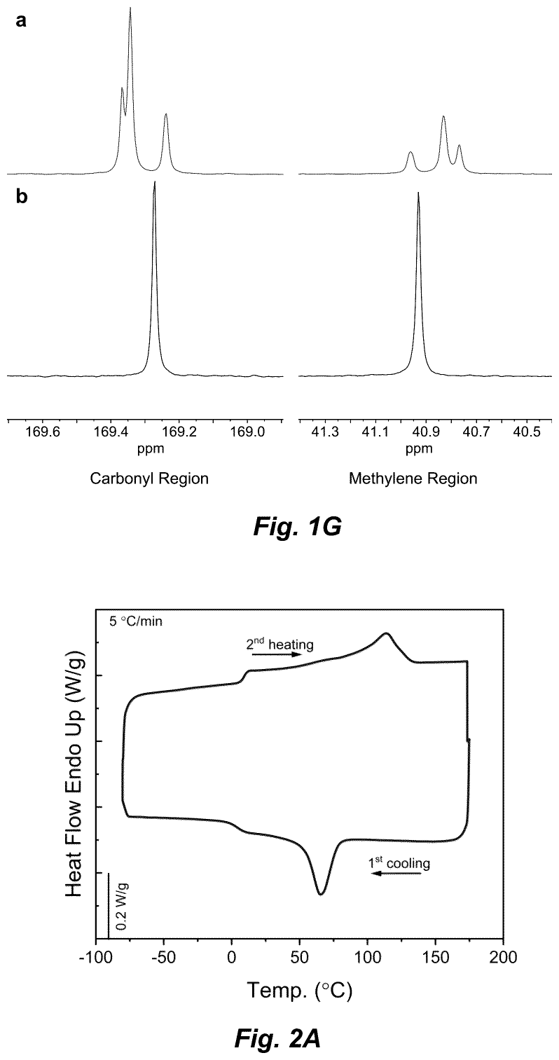

We investigated if the ROP of meso-(R,S)-8DL^{Me} will result in a sr-P3HB, even with an achiral, non-stereoselective catalyst, as repeating units will always produce an r diad and therefore the Pᵣ will always be >0.5. Also unique to this system, the resulting sr-P3HB is inherently devoid of any [mm] triads (FIG. 1). Thus, we hypothesized that a unique balance of stereoregularity-dependent crystallinity and performance properties could be attained through the ROP of meso-8DL^{Me} by a non-stereoselective catalyst, affording sr-P3HB with a controlled level of stereo-defects that can render a suitable level of crystallinity to overcome the above-overviewed tradeoffs between crystallinity and ductility or processability.

Indeed, the sr-P3HB resulted from the ROP of meso-8DL^{Me} consists of 53% [rr], 47% [mr], and 0% [mm], giving a Pᵣ of 0.77. This unique tacticity distribution brings about a synergistic combination of attractive properties, including crystallinity (Tₘ=114° C.), optical transparency (due to very small spherulites), high elongation at break (ϑ_{B}>400%) and tensile strength (σ_{B}=34 MPa), and excellent toughness (U_{T}=96 MJ/m³), while maintaining biodegradability in freshwater and soil.

### Results and Discussion

Synthesis of sr-P3HB by ROP of meso-8DL^{Me} with an Achiral Catalyst. The monomer employed in this study, meso-8DL^{Me}, is considered a (waste) coproduct in the rac-8DL^{Me} synthesis.^{66,67} The ROP of meso-8DL^{Me} at room temperature (RT, ˜25° C.) was investigated using the commercially available, achiral precatalyst La[N(SiMe₃)₂]₃, in combination with 3 equivalents of an alcohol initiator. Amongst the three initiators examined, P₂CHOH outperformed PhCH₂OH, followed by the least effective P₃COH, attributable to the balanced acidity and sterics of P₂CHOH achieving both rapid alcoholysis of the precatalyst and preventing aggregation of the resulting alkoxy catalyst (Table 1, runs 1-3). Upon optimization, the ROP with a [meso-8DL^{Me}]/[La]/[P₂CHOH] ratio of 5000:1:3 (0.02 mol % catalyst) at RT achieved 89% monomer conversion in 22 min, affording high molar mass sr-P3HB with low dispersity (Mₙ=171 kDa, Ð=1.07, Table 1, run 4).

TABLE 1
Selected results of the ROP of meso-8DL^{Me} catalyzed by
[La] with different alcohol initiators. ^{a}

| | | | Time | Conv. | Mₙ^{d} | Ð^{d} | [rr] ^{e} | [mr] ^{e} | |
|---|---|---|---|---|---|---|---|---|---|
| Run | [M]/[La]/[ROH] | [ROH] | (min) | (%)^{c} | (kDa) | (M_{w}/Mₙ) | (%) | (%) | Pᵣ ^{e} |
| 1 | 5000:1:3 | PhCH₂OH | 45 | 75 | 77.3 | 1.05 | 54 | 46 | 0.77 |
| 2 | 5000:1:3 | Ph₂CHOH | 3 | 78 | 146 | 1.09 | 53 | 47 | 0.77 |
| 3 | 5000:1:3 | Ph₃COH | 1,230 | 8 | 35.6 | 1.02 | n.d. | n.d. | n.d. |
| 4 | 5000:1:3 ^{b} | Ph₂CHOH | 22 | 89 | 171 | 1.07 | 53 | 47 | 0.77 |

^{a} Conditions: pre-catalyst [La] = La[N(SiMe₃)₂]₃, monomer (M) = meso-8DL^{Me} = 100 mg (0.58
mmol) in dichloromethane (0.3 mL), 1.94M, ~25° C., except for run 4.
^{b} Conditions for run 4: [La], meso-8DL^{Me} = 1.2 g (7.0 mmol) in dichloromethane (4.6 mL), 1.50M, ~25° C.
^{c}Monomer conversion determined by ¹H NMR analysis.
^{d}Absolute weight-average molecular weight (M_{w}), number-average molecular weight (Mₙ), and dispersity (Ð = M_{w}/Mₙ) determined by size exclusion chromatography (SEC) coupled with a Wyatt DAWN HELEOS II multi (18)-angle light scattering detector and a Wyatt Optilab TrEX dRI detector and performed at 40° C. in chloroform.
^{e} Calculated from semi-quantitative ¹³C NMR spectrum (CDCl₃, 23° C.). n.d. = not determined due to low conversion of this run.

Noteworthy is that the sr-P3HB produced here is inherently different than the st-P3HB obtained from [symbol] -BL as, in principle, it is not possible for the ROP of meso-8DL^{Me} to produce [mm] triads. The lack of [mm] triads is inherent to the coordination-insertion ROP mechanism of meso-8DL^{Me} as two opposite stereocenters are always enchained together at each propagation step, making it impossible for three of the same stereocenters added consecutively without invoking other side reactions such as transesterification (FIG. 1B-C). The stereomicrostructure of sr-P3HB was confirmed by ¹³C NMR analysis, showing no [mm] stereo-sequence but [rr] (53%) and [mr] (47%) and giving Pᵣ=0.77 (FIGS. 1D,1G). The potential epimerization of meso-8DL^{Me} (or racemization to rac-8DL^{Me}) during the ROP process can be ruled out on the basis of the NMR studies that showed no [mm] triads are present in sr-P3HB (FIG. 1G) and that the crude polymerization mixture still containing residual (unreacted) meso-8DL^{Me} showed no formation of rac-8DL^{Me}.

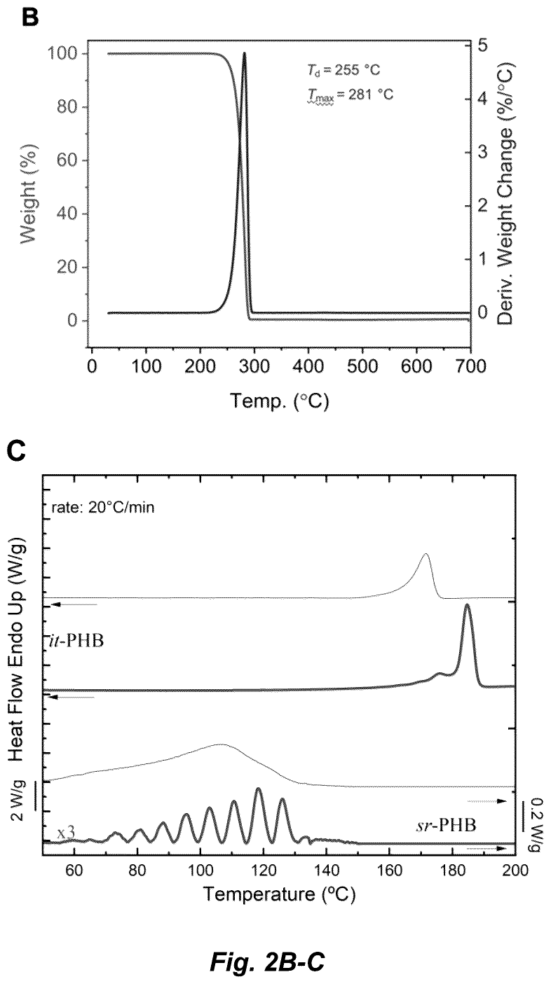

Thermal Properties and Crystallization Behavior. The highly stereoregular it-P3HB and st-P3HB have a high Tₘ of ˜175° C. but a relatively low degradation temperature (T_{d}, defined as the temperature at 5% weight loss) of ˜250° C., which gives a narrow processing window and makes melt-processing challenging.^{63,66} In comparison, sr-P3HB, designed as such herein, exhibits a lower Tₘ of 114° C. (heat of fusion, ΔH_{f}=26.7 J/g), while the T_{d} is maintained at 255° C. (FIGS. 2A,B), thus giving sr-P3HB a much wider processing window. It is apparent that sr-P3HB shows a much broader melting transition than it-P3HB and st-P3HB with higher crystallinity.^{61,67}

To better understand this difference, successive self-nucleation and annealing (SSA) thermal fractionation studies were performed on sr-P3HB and on it-P3HB for comparison purposes.^{74,75,76,77} We found that sr-P3HB can be successfully fractionated by SSA, producing a number of clear and well-resolved thermal fractions (FIG. 2C, bottom thick line curve) with a monomodal distribution. In contrast, it-P3HB has a different SSA thermal fractionation profile:

there is only one main thermal fraction and a minor secondary one, attesting to its highly regular isotactic structure (FIG. 2C, thick line curve near the middle of the y-axis). This behavior occurs because the thermal fractionation ability of any material increases as the number of defects that can interrupt the linear and stereoregular crystallizable sequences increases.

The tacticity defects present in sr-P3HB are randomly distributed along the chain (hence their monomodal distribution of melting peaks after SSA fractionation^{76,77}) and they frequently interrupt crystallizable sequences. This frequent interruption reduces its degree of crystallinity (73% for it-P3HB vs. 15% for sr-P3HB after the SSA treatment) and its melting temperature. The it-P3HB sample is characterized by large spherulites (>150 μm).^{49,50} Instead, sr-P3HB has a morphology characterized by a sub-micron spherulitic texture, which will induce optical transparency as the characteristic crystalline aggregates are smaller than the typical wavelength of visible light (i.e., 400 nm) and will not produce any light scattering. This morphology is a consequence of the much higher nucleation density of sr-P3HB induced by the tacticity defects along the chains.

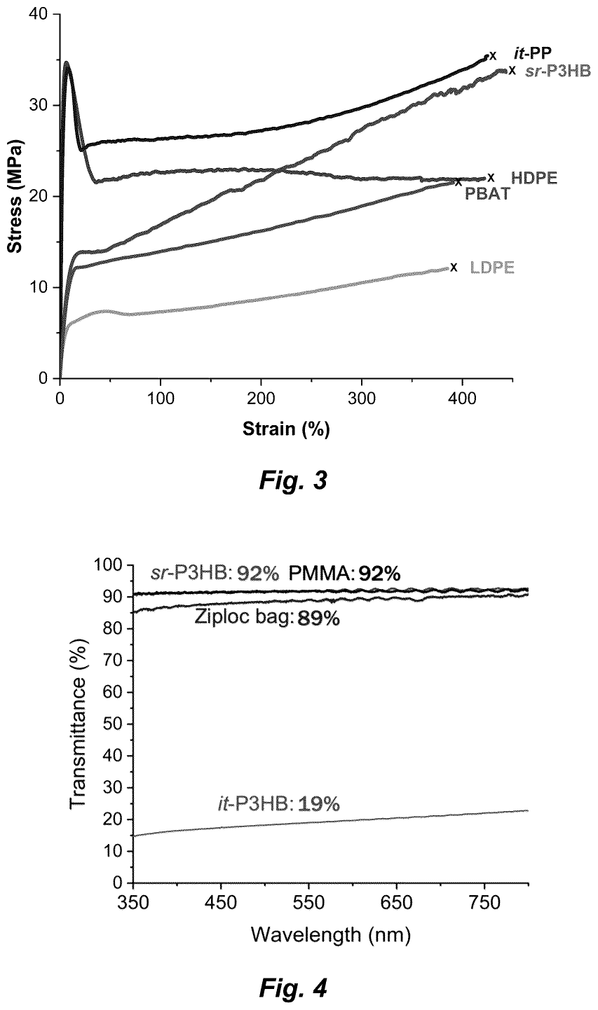

Mechanical Properties. Tensile testing of the sr-P3HB with Mₙ=171 kDa (Ð=1.07) was performed on dog-bone specimens (ASTM D638 standard; Type V), showing a high σ_{B} of 33.8±1.4 MPa and elastic modulus (E) of 217±12 MPa (FIG. 3). More impressively, this sr-P3HB material exhibits an excellent ε_{B} of 419±25% and overall high toughness (UT) of 96±6 MJ/m³, making it over 100 times tougher than it-P3HB (σ_{B}=˜35 MPa, ε_{B}˜3-5%, U_{T}˜0.6-0.9 MJ/m³). This large difference in toughness is because sr-P3HB has a much lower degree of crystallinity and, at the same time, a refined microspherulitic texture that is expected to lead to a higher ductility.

To ascertain the commercial relevance of sr-P3HB, the tensile properties were compared to high-density polyethylene (HDPE), low-density polyethylene (LDPE), polybutylene adipate terephthalate (PBAT), and isotactic polypropylene (it-PP) (FIG. 3). Relative to the high-performance it-PP (Mₙ=97 kDa), the sr-P3HB exhibits comparable CB and CB values. When compared to HDPE (melt flow index, MFI=7.6) and LDPE (MFI=7.5), the sr-P3HB shows a similar ε_{B} but a considerably higher CB. It also outperforms PBAT (Mₙ=88.5 kDa, σ_{B}=21.4 MPa, CB=400%),⁷⁹ a commercialized biodegradable alternative to LDPE. These comparative studies demonstrate that the mechanical properties of sr-P3HB are competitive with both commodity plastics and their established biodegradable alternatives. Worth noting here is that the highly stereoregular st-P3HB (Pᵣ=0.92, Tₘ=169° C., produced by stereoselective ROP of meso-8DL^{Me} with a chiral catalyst) is even too brittle to process into film specimens for tensile testing, behaving much like it-P3HB.

The best mechanical properties of any semicrystalline material are manifested in between T_{g} and Tₘ. Toughness can only develop in this temperature range. As long as the use temperature is above T_{g}, the amorphous chains will be rubbery and flexible, allowing for ductility to develop depending on the degree of crystallinity and morphology of the material (i.e., spherulitic size). In this respect, it-PP also has a T g around 0° C., which limits its applications at temperatures below T_{g} because it will develop a brittle behavior. Even at room temperature, it-PP can be fragile (especially at high loading speeds, like during impact testing) if the thermal history (slow cooling) allows for the production of large spherulites and high crystallinity. This is why nucleating agents are usually added to it-PP to reduce the spherulitic size and produce a refined microspherulitic morphology affording transparency and toughness.

Likewise, P3HB also has a T g value of around 0° C. or slightly below zero, depending on its stereoregularity and molar mass, and also develops large spherulites which concentrate stresses and provoke brittle fracture. In this work, the unique set of stereomicrostructures comprising enriched (53%) syndiotactic [rr], no isotactic [mm], triads, but abundant (47%) stereo-defects ([mr]) randomly distributed along the polymer chain interrupts the perfectly regular crystallizable sequences achieving two important effects: increasing nucleation density (hence producing a sub-microspherulitic morphology leading to excellent transparency) and reducing crystallinity. Both effects, considering that room temperature is at least 25° C. above T_{g}, are crucial to significantly improve toughness.

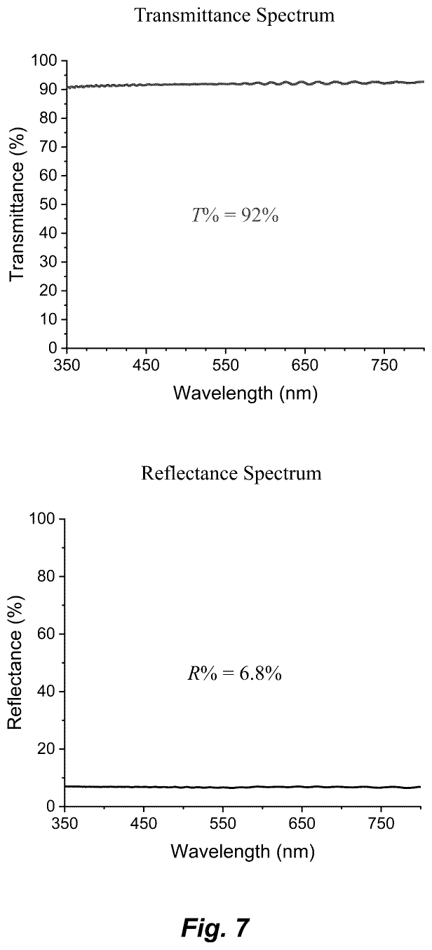

Optical and Barrier Properties. The semicrystalline sr-P3HB was found to be optically clear by analysis of its transmittance and reflectance properties using an Ultraviolet-visible Near InfraRed (UV-vis-NIR) spectrophotometer, displaying a transmittance value (T%) of 92% and a reflectance value of 6.8% when scanned in the visible range (350 nm to 800 nm) (FIG. 7). Comparing to the transmittance values of commercial materials well-known for their excellent optical properties, sr-P3HB is as good as poly(methyl methacrylate) (PMMA; T%=92%) and a 40-gallon Ziploc® Bag (LDPE, T%=89%), and far superior to it-P3HB (T%=19%) (FIG. 4). This high value of the transmittance registered for sr-P3HB is due to its particular morphology constituted by very small superstructural aggregates (i.e., sub-micron spherulites), unlike the low value of the it-P3HB transmittance, which is due to its much larger spherulites.

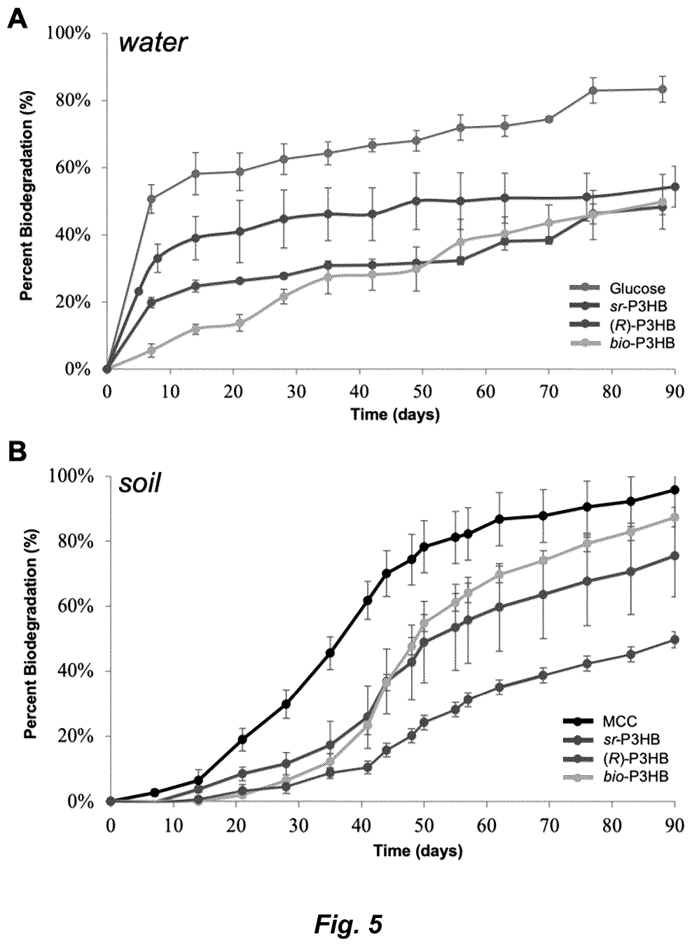

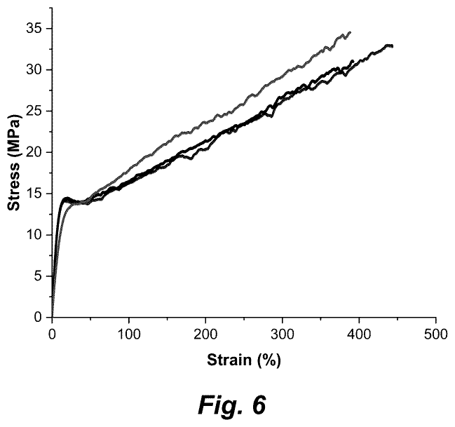

Biodegradability in Freshwater and Soil. The enzymatic degradation of P3HB with unnatural stereomicrostructures was investigated previously by Doi et al. using PHB depolymerase from Pseudomonas pickettii, and they reported that the rate of biodegradation depends on tacticity and that the sr-P3HB (Pᵣ=0.70) samples derived from the ROP of [symbol] -BL hardly degraded.⁷³ The biodegradability of the sr-P3HB produced by the ROP of meso-8DL^{Me} in this study was investigated in both freshwater and soil following the ISO 14851 and ASTM D5988-18 standards, respectively. Within 90 days, sr-P3HB reached ˜54% biodegradation under freshwater environment (25° C.), which is similar to that observed for the synthetic (R)-P3HB ([mm]>0.99 produced by the enantioselective ROP of rac-8DL^{Me}) and the biologically produced (R)-P3HB (bio-P3HB) (FIG. 5A). In soil environment, after 90 days sr-P3HB reached 50% biodegradation (FIG. 5B). Through first-order kinetics, it can be predicted that sr-P3HB will reach 90% biodegradation in ˜268 days in soil and ˜383 days in freshwater. For comparison, synthetic (R)-P3HB is estimated to reach 90% biodegradation in 145 days in soil and 433 days in freshwater. The bio-P3HB has a similarly estimated lifetime of 105 days in soil and 282 days in freshwater.

It is interesting to note that, relative to bio-P3HB and synthetic (R)-P3HB, sr-P3HB displayed a faster 90-day biodegradation in freshwater (FIG. 5A) but a slower biodegradation in soil (FIG. 5B). These differences may be attributed to the fact that freshwater and soil environments have different microbial populations and that the two testing environments differ modestly in temperature (freshwater at 25° C. vs soil at room temperature) and pH (freshwater at 7.2 vs soil 7.4). Overall, these results suggest that if sr-P3HB is leaked into the soil or freshwater environment it will efficiently biodegrade and leave no long-term accumulation in these environments.

In summary, we have synthesized sr-P3HB from the non-stereoselective ROP of meso-8DL^{Me}, the (waste) coproduct in the racemic diolide synthesis, using a simple, commercial, achiral catalyst. Thorough structure and property characterizations have revealed the unique set of stereomicrostructures of the current sr-P3HB, which are different than the previously disclosed sr-P3HB materials derived from the ROP of [symbol] -BL, and subsequently uncovered uniquely combined attractive properties, including crystallinity, optical transparency, toughness, commercially relevant barrier properties, and biodegradability. The stereomicrostructure of the sr-P3HB comprises enriched (53%) [rr] and no [mm] triads but abundant (47%) stereo-defects ([mr+rm]) randomly distributed along the chain. The origin of this unique set of stereomicrostructures for the sr-P3HB produced here is attributed to the meso-monomer structure, (R,S)-8DL^{Me}, and the non-stereoselectivity in the coordination-insertion ROP mechanism.

A particularly interesting and broader insight obtained from this work is that the randomly distributed, abundant stereo-defects along the sr-P3HB chain frequently interrupt crystallizable sequences and thus create a refined sub-microspherulitic morphology that leads to the observed high optical transparency and ductility despite being semicrystalline with high tensile strength. In a nutshell, the stereo-defects present in sr-P3HB render its superior materials properties in comparison to those of stereo-perfect or highly stereoregular it-P3HB and st-P3HB. More broadly, these results further the more sustainable, mono-material design approach that creates a diverse range of materials properties of polymers via stereomicrostructural engineering without changing their chemical composition.

Background and Poly(3-hydroxybutyrate) by Stereomicrostructural Engineering Citations.
(2) Jehanno, C.; Alty, J. W.; Roosen, M.; De Meester, S.; Dove, A. P.; Chen, E. Y.-X.; Leibfarth, F. A.; Sardon, H. Critical Advances and Future Opportunities in Upcycling Commodity Polymers. Nature 2022, 603, 803-814.
(5) Hong, M.; Chen, E. Y.-X. Chemically Recyclable Polymers: A Circular Economy Approach to Sustainability. Green Chem. 2017, 19, 3692-3706.
(9) Shi, C.; Reilly, L. T.; Phani Kumar, V. S.; Coile, M. W.; Nicholson, S. R.; Broadbelt, L. J.; Beckham, G. T.; Chen, E. Y.-X. Design Principles for Intrinsically Circular Polymers with Tunable Properties. Chem 2021, 7, 2896-2912.
(10) Ellis et al., Chemical and Biological Catalysis for Plastics Recycling and Upcycling. Nat. Catal. 2021, 4, 539-556.
(16) Tang, X.; Chen, E. Y.-X. Toward Infinitely Recyclable Plastics Derived from Renewable Cyclic Esters. Chem 2019, 5, 284-312.
(22) Cywar, R. M.; Rorrer, N. A.; Hoyt, C. B.; Beckham, G. T.; Chen, E. Y.-X. Bio-Based Polymers with Performance-Advantaged Properties. Nat. Rev. Mater. 2022, 7, 83-103.
(26) Sudesh, K.; Abe, H.; Doi, Y. Synthesis, Structure and Properties of Polyhydroxyalkanoates: Biological Polyesters. Prog. Polym. Sci. 2000, 25, 1503-1555.
(36) Westlie, A. H.; Quinn, E. C.; Parker, C. R.; Chen, E. Y.-X. Synthetic Biodegradable Polyhydroxyalkanoates (PHAs): Recent Advances and Future Challenges. Prog. Polym. Sci. 2022, 134, 101608.
(37) Adamus, G.; Domiński, A.; Kowalczuk, M.; Kurcok, P.; Radecka, I. From Anionic Ring-Opening Polymerization of β-Butyrolactone to Biodegradable Poly(Hydroxyalkanoate)s: Our Contributions in This Field. Polymers 2021, 13, 4365.
(38) Li et al., Recent Advances in Metal-Mediated Stereoselective Ring-Opening Polymerization of Functional Cyclic Esters towards Well-Defined Poly(Hydroxy Acid)s: From Stereoselectivity to Sequence-Control. Chem. Eur. J. 2020, 26, 128-138.
(40) Sangroniz, A.; Zhu, J. B.; Tang, X.; Etxeberria, A.; Chen, E. Y.-X.; Sardon, H. Packaging Materials with Desired Mechanical and Barrier Properties and Full Chemical Recyclability. Nat. Commun. 2019, 10, 3559.
(41) Dove, A. P. Organic Catalysis for Ring-Opening Polymerization. ACS Macro Lett. 2012, 1, 1409-1412.

### (42) Dunn, E. W.; Coates, G. W. Carbonylative Polymerization of Propylene Oxide: A

Multicatalytic Approach to the Synthesis of Poly(3-Hydroxybutyrate). J. Am. Chem. Soc. 2010, 132, 11412-11413.

(43) Rieth, L. R.; Moore, D. R.; Lobkovsky, E. B.; Coates, G. W. Single-Site β-Diiminate Zinc Catalysts for the Ring-Opening Polymerization of β-Butyrolactone and β-Valerolactone to Poly(3-Hydroxyalkanoates). J. Am. Chem. Soc. 2002, 124, 15239-15248.
(44) Bruckmoser, J.; Henschel, D.; Vagin, S.; Rieger, B. Combining High Activity with Broad Monomer Scope: Indium Salan Catalysts in the Ring-Opening Polymerization of Various Cyclic Esters. Catal. Sci. Technol. 2022, 12, 3295-3302.
(45) Poirier, V.; Roisnel, T.; Carpentier, J. F.; Sarazin, Y. Versatile Catalytic Systems Based on Complexes of Zinc, Magnesium and Calcium Supported by a Bulky Bis(Morpholinomethyl)Phenoxy Ligand for the Large-Scale Immortal Ring-Opening Polymerisation of Cyclic Esters. Dalton Trans. 2009, 9820-9827.
(46) Kaminsky, W.; Funck, A.; Hähnsen, H. New Application for Metallocene Catalysts in Olefin Polymerization. Dalton Trans. 2009, 8803-8810.
(47) Kamber, N. E.; Jeong, W.; Waymouth, R. M.; Pratt, R. C.; Lohmeijer, B. G. G.; Hedrick, J. L. Organocatalytic Ring-Opening Polymerization. Chem. Rev. 2007, 107, 5813-5840.
(48) Mahrova, T. V.; Fukin, G. K.; Cherkasov, A. V.; Trifonov, A. A.; Ajellal, N.; Carpentier, J. F. Yttrium Complexes Supported by Linked Bis(Amide) Ligand: Synthesis, Structure, and Catalytic Activity in the Ring-Opening Polymerization of Cyclic Esters. Inorg. Chem. 2009, 48, 4258-4266.
(49) Connor, E. F.; Nyce, G. W.; Myers, M.; Mock, A.; Hedrick, J. L. First Example of N-Heterocyclic Carbenes as Catalysts for Living Polymerization: Organocatalytic Ring-Opening Polymerization of Cyclic Esters. J. Am. Chem. Soc. 2002, 124, 914-915.
(50) Yang, J. C.; Yang, J.; Li, W. B.; Lu, X. B.; Liu, Y. Carbonylative Polymerization of Epoxides Mediated by Tri-Metallic Complexes: A Dual Catalysis Strategy for Synthesis of Biodegradable Polyhydroxyalkanoates. Angew. Chem. Int. Ed. 2022, 61, e2021162.
(51) Tani, H.; Yamashita, S.; Teranishi, K. Stereospecific Polymerization of β-Methyl-β-Propiolactone. Polym. J. 1971, 3, 417-418.
(54) Bloembergen et al., Stereoregularity in Synthetic β-Hydroxybutyrate and β-Hydroxyvalerate Homopolyesters. Macromolecules 1989, 22, 1656-1663.
(56) Zintl, M.; Molnar, F.; Urban, T.; Bernhart, V.; Preishuber-Pflügl, P.; Rieger, B. Variably Isotactic Poly(Hydroxybutyrate) from Racemic β-Butyrolactone: Microstructure Control by Achiral Chromium(III) Salophen Complexes. Angew. Chem., Int. Ed. 2008, 47, 3458-3460.
(57) Ajellal, N.; Durieux, G.; Delevoye, L.; Tricot, G.; Dujardin, C.; Thomas, C. M.; Gauvin, R. M. Polymerization of Racemic β-Butyrolactone Using Supported Catalysts: A Simple Access to Isotactic Polymers. Chem. Commun. 2010, 46, 1032-1034.
(60) Bouyahyi, M.; Ajellal, N.; Kirillov, E.; Thomas, C. M.; Carpentier, J. F. Exploring Electronic versus Steric Effects in Stereoselective Ring-Opening Polymerization of Lactide and β-Butyrolactone with Amino-Alkoxy-Bis(Phenolate)-Yttrium Complexes. Chem. Eur. J. 2011, 17, 1872-1883.
(61) Amgoune, A.; Thomas, C. M.; Ilinca, S.; Roisnel, T.; Carpentier, J. F. Highly Active, Productive, and Syndiospecific Yttrium Initiators for the Polymerization of Racemic β-Butyrolactone. Angew. Chem., Int. Ed. 2006, 45, 2782-2784.
(62) Zhuo, Z.; Zhang, C.; Luo, Y.; Wang, Y.; Yao, Y.; Yuan, D.; Cui, D. Stereo-Selectivity Switchable ROP of: Rac-β-Butyrolactone Initiated by Salan-Ligated Rare-Earth Metal Amide Complexes: The Key Role of the Substituents on Ligand Frameworks. Chem. Commun. 2018, 54, 11998-12001.
(63) Ajellal et al., Syndiotactic-Enriched Poly(3-Hydroxybutyrate)s via Stereoselective Ring-Opening Polymerization of Racemic β-Butyrolactone with Discrete Yttrium Catalysts. Macromolecules 2009, 42, 987-993.
(64) Kemnitzer, J. E.; Mccarthy, S. P.; Gross, R. A. Syndiospecific Ring-Opening Polymerization of β-Butyrolactone To Form Predominantly Syndiotactic Poly(β-Hydroxybutyrate) Using Tin(IV) Catalysts. Macromolecules 1993, 26, 6143-6150.

### (65) Ebrahimi, T.; Aluthge, D. C.; Hatzikiriakos, S. G.; Mehrkhodavandi, P. Highly Active Chiral Zinc Catalysts for Immortal Polymerization of β-Butyrolactone Form Melt Processable Syndio-Rich Poly(Hydroxybutyrate). Macromolecules 2016, 49, 8812-8824.

(66) Tang, X.; Chen, E. Y.-X. Chemical Synthesis of Perfectly Isotactic and High Melting Bacterial Poly(3-Hydroxybutyrate) from Bio-Sourced Racemic Cyclic Diolide. Nat. Commun. 2018, 9, 2345.
(67) Tang, X.; Westlie, A. H.; Watson, E. M.; Chen, E. Y.-X. Stereosequenced Crystalline Polyhydroxyalkanoates from Diastereomeric Monomer Mixtures. Science 2019, 366, 754-758.
(68) Zhang, Z.; Shi, C.; Scoti, M.; Tang, X.; Chen, E. Y.-X. Alternating Isotactic Polyhydroxyalkanoates via Site- and Stereoselective Polymerization of Unsymmetrical Diolides. J. Am. Chem. Soc. 2022, 144, 20016-20024.
(69) Tang, X.; Westlie, A. H.; Caporaso, L.; Cavallo, L.; Falivene, L.; Chen, E. Y.-X. Biodegradable Polyhydroxyalkanoates by Stereoselective Copolymerization of Racemic Diolides: Stereocontrol and Polyolefin-Like Properties. Angew. Chem., Int. Ed. 2020, 59, 7881-7890.
(70) Tang, X.; Shi, C.; Zhang, Z.; Chen, E. Y.-X. Toughening Biodegradable Isotactic Poly(3-Hydroxybutyrate) via Stereoselective Copolymerization of a Diolide and Lactones. Macromolecules 2021, 54, 9401-9409.
(71) Tang, X.; Zhang, Z.; Chen, E. Y.-X. Crystalline Aliphatic Polyesters from Eight-Membered Cyclic (Di) Esters. J. Polym. Sci. 2022, 60, 3478-3488..
(72) Worch, J. C.; Prydderch, H.; Jimaja, S.; Bexis, P.; Becker, M. L.; Dove, A. P. Stereochemical Enhancement of Polymer Properties. Nat. Rev. Chem. 2019, 3,514-535.
(73) Abe, H.; Matsubara, I.; Doi, Y.; Hori, Y.; Yamaguchi, A. Physical Properties and Enzymic Degradability of Poly(3-Hydroxybutyrate) Stereoisomers with Different Stereoregularities. Macromolecules 1994, 27, 6018-6025.
(74) Muller, a J.; Hernandez, Z. H.; Arnal, M. L.; Sanchez, J. J. A Novel Technique to Study Molecular Segregation during Crystallization. Polym. Bull. 1997, 472, 465-472.
(75) Arnal et al., Applications of Successive Self-Nucleation and Annealing (SSA) to Polymer Characterization. J. Therm. Anal. calorim. 2000, 59, 451-470.
(76) Müller, A. J.; Michell, R. M.; Pérez, R. A.; Lorenzo, A. T. Successive Self-Nucleation and Annealing (SSA): Correct Design of Thermal Protocol and Applications. Eur. Polym. J. 2015, 65, 132-154.
(77) Pérez-Camargo, R. A.; Cavallo, D.; Müller, A. J. Recent Applications of the Successive Self-Nucleation and Annealing Thermal Fractionation Technique. Front. Soft Matter 2022, 2, 1003500.
(78) Caputo, M. R.; Tang, X.; Westlie, A. H.; Sardon, H.; Chen, E. Y.-X.; Milner, A. J. Effect of Chain Stereoconfiguration on Poly (3-Hydroxybutyrate) Crystallization Kinetics. Biomacromolecules 2022, 23, 3847-3859.
(79) Sangroniz et al., Blends of Biodegradable Poly(Butylene Adipate-Co-Terephthalate) with Poly(Hydroxi Amino Ether) for Packaging Applications: Miscibility, Rheology and Transport Properties. Eur. Polym. J. 2018, 105, 348-358.

### Embodiments of the Invention

The invention provides various unique stereomicrostructure syndio-rich (sr) P3HB and iso-rich (ir) P3HB compositions and their applications as (i) high-performance ductile and tough thermoplastics, (ii) in toughening of brittle biological (purely isotactic) or synthetic P3HB through physical blending, and (iii) as strong adhesives for metal, glass, and wood surfaces. Certain examples of the invention include the following enumerated statements. The embodiments described by these statements can be used alone or in combination with other aspects or embodiments described herein. The invention thus provides:

1. A polymer comprising a syndio-rich poly(3-hydroxyalkanoate) of formula I, or an iso-rich poly(3-hydroxyalkanoate) of formula II:
wherein,

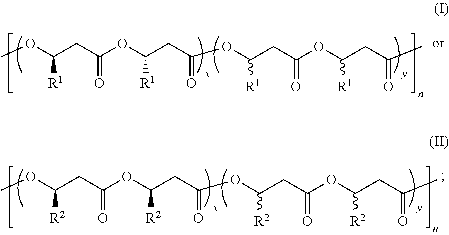

R¹ are each (C₁-C₁₈)alkyl, (C₁-C₈)alkenyl, (C₁-C₈)alkynyl, benzyl, or aryl; or
R² are each (C₁-C₁₈)alkyl, (C₁-C₈)alkenyl, (C₁-C₈)alkynyl, benzyl, or aryl;

x are syndiotactic triads (rr) in the polymer of formula I, wherein the syndiotactic triads have at least 95% alternating (R) and (S) stereochemical configurations with respect to the stereocenters of substituents R¹ on the polymer chain;

y are heterotactic triads (mr or rm) in the polymer of formula I, wherein the heterotactic triads have random (e.g., 50% probability) stereochemical configurations with respect to the stereocenters of substituents R¹ on the polymer chain;

wherein repeat units of y are randomly distributed between repeat units of x throughout the polymer chain; or
x are isotactic triads (mm) in the polymer formula II, wherein the isotactic triads have at least 95% consecutive (R) stereochemical configurations or 95% consecutive (S) stereochemical configurations with respect to the stereocenters of substituents R² on the polymer chain;
y are heterotactic triads (mr or rm) in the polymer of formula II, wherein the heterotactic triads have random stereochemical configurations with respect to the stereocenters of substituents R² on the polymer chain;
wherein repeat units of y are randomly distributed between repeat units of x throughout the polymer chain; and

n is about 10 to about 5,000.

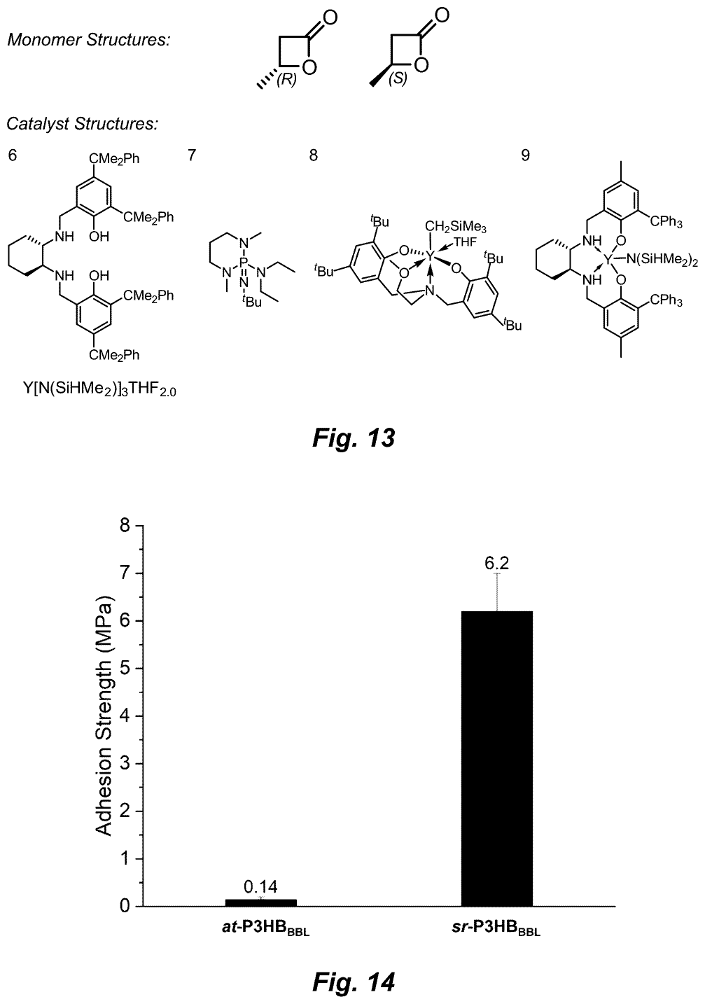

2. The polymer of statement 1 wherein the probability of racemic linkages between two consecutive monomer units (Pᵣ) for formula I is about 0.5 to about 0.95 and/or the mole% of syndiotactic triads (rr) present in formula I is about 25% to about 90%.
3. The polymer of statement 1 or 2 wherein the probability of racemic linkages between two consecutive monomer units (Pᵣ) for formula I is about 0.65 to about 0.92, or about 0.7 to about 0.92; and/or the mole% of syndiotactic triads (rr) present in formula I is about 40% to about 85%, about 42% to about 85%, or about 50% to about 85%. For example, sr-P3HB produced by catalyst Y-tBu (FIG. 13, catalyst structure 6) has very good adhesion, with an [rr] of 42%.
4. The polymer of any one of statements 1-3 wherein the probability of meso linkages between monomer units (Pₘ) for formula II is about 0.5 to about 0.95 and/or the mole% of isotactic triads (mm) present in formula II is about 25% to about 90%.
5. The polymer of statement 4 wherein the probability of meso linkages between monomer units (Pₘ) for formula II is about 0.7 to about 0.94, about 0.7 to about 0.92, or about 0.7 to about 0.9 and/or the mole% of isotactic triads (mm) present in formula II is about 50% to about 87%, or about 50% to about 85%.
6. The polymer of any one of statements 1-5 wherein each R¹ of formula I is methyl and the polymer is syndio-rich poly(3-hydroxybutyrate) (sr-P3HB).
7. The polymer of any one of statements 1-6 wherein each R² of formula II is methyl and the polymer is iso-rich poly(3-hydroxybutyrate) (ir-P3HB).
8. A polymer blend comprising a polymer of formula I or formula II of any one of statements 1-7 and biologically or synthetically produced stereo perfect poly(3-hydroxybutyrate) (sp-P3HB), wherein sp-P3HB is:

a purely isotactic aliphatic polyester having an absolute (R) or (S) stereochemical configuration; or

a purely syndiotactic polyester having an alternating (R) and (S) stereochemical configuration.

9. The polymer blend of statement 8 wherein the weight % ratio of a polymer of formula I to sp-P3HB or a polymer of formula II to sp-P3HB is about 1:9 to about 9:1; or wherein the wt.% ratio is about 1:9 to about 1:1.
10. The polymer blend of statement 8 wherein the polymer blend has an optical clarity above about 50% visible light transmittance. The optical clarity in semi-crystalline sr-P3HB and ir-P3HB is due to their ability to form spherulites or crystallites under sub-micron sizes, typically less than 400 nm, so there is little or no scattering of visible light (400-800 nm), rendering the semi-crystalline sr-P3HB and ir-P3HB to possess properties of high optical clarity or actual transparency. The blends with bio- and synthetic P3HB materials with stereoperfect isotactic structure, which do not exhibit optical clarity before forming a blend, also become optically clear, with a high visible light transmittance of 84-85%, from all the blend ratios of ir-P3HB/sp-P3HB or sr-P3HB/sp-P3HB for weight% ratios of 10/90 to 90/10.
11. A method for a ring opening polymerization (ROP) reaction for preparing a polymer according to any one of statements 1-7, the method comprising: contacting i) an effective amount of a metal catalyst; ii) an alcohol initiator, wherein the alcohol initiator is P₂CHOH, PhCH₂OH, or P₃COH; and iii) a monomer of formula III, or a racemic mixture of a monomer of formula IV and a monomer of formula V:

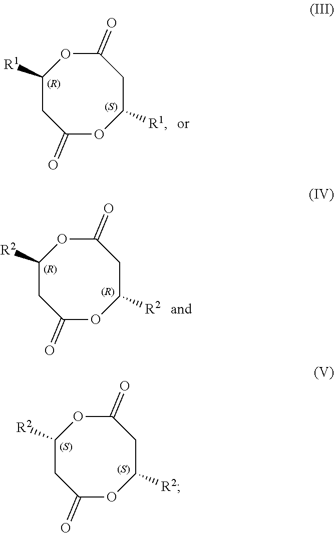

wherein,

R¹ are each (C₁-C₁₈)alkyl, (C₁-C₈)alkenyl, (C₁-C₈)alkynyl, benzyl, or aryl; or
R² are each (C₁-C₁₈)alkyl, (C₁-C₈)alkenyl, (C₁-C₈)alkynyl, benzyl, or aryl; and the metal catalyst is La[N(Si(CH₃)₂]₃; or
the metal catalyst is a metal complex of formula VI:

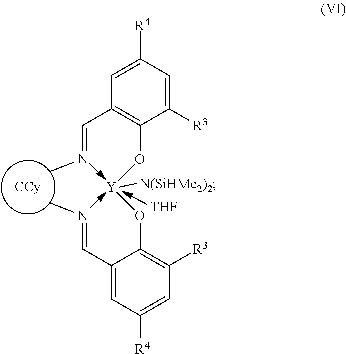

wherein,

CCy is A or B:

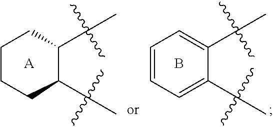

each R³ is tent-butyl, CPh₃, or C(CH₃)₂Ph; and

each R⁴ is tent-butyl, CH₃, or C(CH₃)₂Ph;

wherein a syndio-rich poly(3-hydroxyalkanoate) or an iso-rich poly(3-hydroxyalkanoate) is thereby formed.
12. The method of statement 11 wherein each R¹ of formula III is methyl, or each R² of formula IV or formula V is methyl.
13. The method of statement 11 or 12 wherein the monomer of formula III is meso-8DL^{Me}:

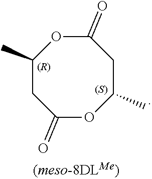

14. The method of any one of statements 11-13 wherein the metal catalyst is La[N(Si(CH₃)₂]₃; or wherein the metal catalyst is a complex of formula VI wherein CCy is A, and each R³ and R⁴ is tent-butyl.
15. The method of any one of statements 11-14 wherein the syndio-rich poly(3-hydroxyalkanoate) formed is syndio-rich poly(3-hydroxybutyrate) (sr-P3HB), wherein the probability of racemic linkages between two consecutive monomer units (Pᵣ) is about 0.7 to about 0.94, about 0.7 to about 0.92, about 0.7 to about 0.9, about 0.65 to about 0.94, about 0.65 to about 0.92, about 0.65 to about 0.9, and/or the mole% of syndiotactic triads (rr) present is about 50% to about 87%, about 50% to about 85%, about 45% to about 87%, about 45% to about 85%, about 40% to about 87%, or about 40% to about 85%.
16. The method of any one of statements 11-15 wherein the monomer of formula IV and the monomer of formula V in a racemic mixture is rac-8DL^{Me}:

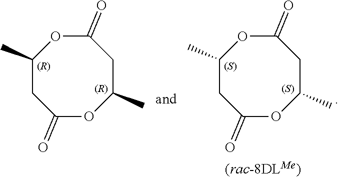

17. The method of statement 16 wherein the metal catalyst is a complex of formula VI wherein CCy is B and each R³ and R⁴ is tent-butyl.
18. The method of statement 17 wherein the iso-rich poly(3-hydroxyalkanoate) formed is iso-rich poly(3-hydroxybutyrate) (ir-P3HB), wherein the probability of meso linkages between monomer units (Pₘ) is about 0.7 to about 0.94, about 0.7 to about 0.92, or about 0.7 to about 0.9, and/or the mole% of isotactic triads (mm) present is about 50% to about 87%, or about 50% to about 85%.
19. The method of any one of statements 11-18 further comprising blending the polymer and biologically or synthetically produced stereo perfect poly(3-hydroxybutyrate) (sp-P3HB), wherein sp-P3HB is a purely isotactic aliphatic polyester with an absolute (R) stereochemical configuration or an absolute (S) stereochemical configuration; or

a purely syndiotactic polyester with an alternating (R) and (S) stereochemical configuration;

wherein the weight% ratio of the polymer to sp-P3HB is about 1:9 to about 9:1. Compounding (melt extrusion), solution processing (dissolution and mixing), or other suitable methods known to those of skill in the art can be used for blending the polymers described herein.

20. An adhesive polymer comprising a polymer according to any one of statements 1-7, wherein the adhesive polymer adheres to aluminum, steel, glass, or wood at an adhesion strength of about 4 MPa or greater.

The syndio-rich poly(3-hydroxybutyrate) (sr-P3HB) and iso-rich poly(3-hydroxybutyrate) (ir-P3HB) prepared as described herein are useful as adhesives. Suitable sr-P3HB and ir-P3HB compositions for use as adhesives are as follows:

sr-P3HB general range: Pᵣ=0.50-0.95, [rr]=25-90%;

sr-P3HB preferred range: Pᵣ=0.70-0.92, [rr]=50-85%;

ir-P3HB general range: Pₘ=0.50-0.95, [mm]=25-90%;

ir-P3HB preferred range: Pₘ=0.70-0.92, [mm]=50-85%.

wherein Pᵣ is the probability of racemic linkages between two consecutive monomer units, Pₘ is the probability of meso linkages between monomer units, [rr] is the mole% of syndiotactic triads, and [mm] is the mole% of isotactic triads.

The same ranges of composition properties can be used when the P3HB material is blended with stereoperfect P3HB (i.e., biological P3HB or isotactic synthetic P3HB). In various embodiments, the blend ratios can be as follows:

General sr-P3HB/sp-P3HB: 10%/90% to 90%/10%; and

Preferred sr-P3HB/sp-P3HB: 50%/50% to 10%/90%.

Further embodiments of the invention include:

11A. A method for a ring opening polymerization (ROP) reaction for preparing an iso-rich poly(3-hydroxyalkanoate) (ir-P3HB), the method comprising: contacting i) an effective amount of a metal catalyst; ii) an alcohol initiator, wherein the alcohol initiator is P₂CHOH, PhCH₂OH, or P₃COH; and iii) a racemic or scalemic mixture of β-butyrolactone (BBL);

wherein the metal catalyst is metal complex 6:

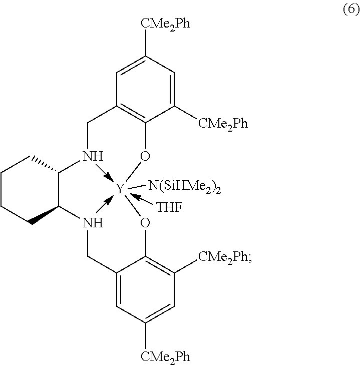

wherein an ir-P3HB is thereby formed.

11B. A method for a ring opening polymerization (ROP) reaction for preparing a syndio-rich poly(3-hydroxyalkanoate) (sr-P3HB), the method comprising: contacting i) an effective amount of a metal catalyst; ii) an alcohol initiator, wherein the alcohol initiator is P₂CHOH, PhCH₂OH, or P₃COH; and iii) a racemic or scalemic mixture of β-butyrolactone (BBL);

wherein the metal catalyst is metal complex 8:

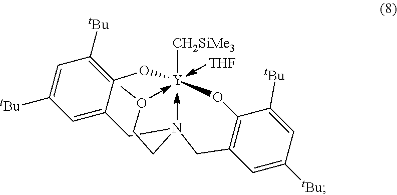

wherein an sr-P3HB is thereby formed.

Variations of statements 11A and 11B can include various elements of the relevant statements above and the variations otherwise described above and in the Examples below.

The following Examples are intended to illustrate the above invention and should not be construed as to narrow its scope. One skilled in the art will readily recognize that the Examples suggest many other ways in which the invention could be practiced. It should be understood that numerous variations and modifications may be made while remaining within the scope of the invention.

### EXAMPLES

### General Materials and Methods.

Air and moisture-sensitive reactions were conducted in oven- or flame-dried glassware on a dual manifold N₂/vacuum Schlenk line or inside an N₂-filled glovebox.

The following reagents were used as received: dimethyl 2,5-dioxocyclohexane-1,4-dicarboxylate (Alfa Aesar), La[N(SiMe₃)₂]₃ (Sigma-Aldrich), iodomethane (Oakwood), and 1,1,3,3-tetramethyldisilazane (TCI, America). Meta-chloroperoxybenzoic acid (m-CPBA) (Sigma-Aldrich) was purified before use by dissolving in diethyl ether, washing organic layer with brine, dried with anhydrous Na₂SO₄, and concentrated in vacuo to remove water.

Monomer (meso-8DL^{Me}) and initiators (P₂CHOH, and P₃COH) were sublimated twice before use in polymerizations. BnOH was stirred over CaH₂ overnight under N₂ and then distilled before use. HPLC-grade dichloromethane was first sparged extensively with nitrogen during filling 20 L solvent reservoirs and then dried by passage through activated alumina.

Poly(methyl methacrylate) (PMMA, powder, Mₙ=120 kDa, 182230), and isotactic polypropylene (it-PP, 5 mm gran., Mₙ=97.0 kDa, 427861) were purchased from Sigma-Aldrich. Low-density polyethylene (LDPE, 3-4 mm granules, MFI=7.5, Product Code INEOS LDPE 19N430) was purchased from INEOS Olefins & Polymers Europe, and high-density polyethylene (HDPE, 2-4 mm gran., MFI=7.6, Product Code ET32-GL-000110) were purchased from Goodfellow. Polybutylene adipate terephthalate (PBAT, M_{w}=75000 Da) was purchased from Basf (Ecoflex F Blend C1200). All polymers were used as received. 40-gallon Ziploc bags were purchased from Walmart and tested as purchased.

(R)-P3HB was synthesized according to literature procedures (Tang and Chen, Nat. Commun. 2018, 9, 2345), [rac-8DL^{Me}]:[cat]:[BnOH] ratio of 800:1:1) for use in biodegradation studies. The Mₙ was determined to be 110 kDa, Ð=1.06. it-P3HB used for comparison was synthesized according to literature procedures' ([rac-8DL^{Me}]: [cat]: [Bn0H] ratio of 800:1:1) for comparison. The Mₙ was determined to be 77.8 kDa, Ð=1.13.

The microbial community structure was characterized and analyzed based on high-throughput 16S rRNA sequencing (Shen et al., J. Clean. Prod. 2017, 167, 863-874).

Spectroscopic Characterizations. NMR spectra were recorded on a Varian Inova or Bruker AV-III 400 MHz spectrometer (400 MHz, ¹H; 100 MHz, ¹³C). Chemical shifts for ¹H and ¹³C spectra were referenced to internal solvent resonance 7.26 (chloroform) and are reported as parts per million relative to SiMe₄. [mm], [rr], and [rm]+[mr] values of P3HB were calculated according to the integration area of mm, rr, and mr+rm triads [A(mm), A(rr), A(mr+rm)] of the methylene group region at δ 40.93, 40.84 ppm, and 40.78+40.98 ppm respectively, which is calculated as [rr]=A(rr)/[A(mm)+A(rr)+A(mr+rm)] and so on.

Absolute Molecular Weight Measurements. Measurements of polymer absolute weight-average molecular weight (M_{w}), number-average molecular weight (Mₙ), and molecular weight distributions or dispersity indices (Ð=M_{w}/Mₙ) were performed via size exclusion chromatography (SEC). The SEC instrument consisted of an Agilent HPLC system equipped with one guard column and two or three PLgel 5 μm mixed-C gel permeation columns and coupled with a Wyatt DAWN HELEOS II multi (18)-angle light scattering detector and a Wyatt Optilab TrEX dRI detector; the analysis was performed at 40° C. using chloroform as the eluent at a flow rate of 1.0 mL/min, using Wyatt ASTRA 7.1.2 molecular weight characterization software. Samples were run using the “assume 100% mass recovery option” which calculated a dn/dc (0.0282 mg/mL) internally based on a precisely known polymer concentration of the sample prior to injection, which were 2.004.00 mg/mL.

Thermal Analysis. Differential Scanning calorimetry (DSC) was performed on an Auto Q20, TA Instrument, on polymer samples which were dried at ˜60° C. overnight. DSC Plots show the melting transition temperature (Tₘ), glass transition temperature (T_{g}), crystallization temperature (T_{c}), and heating of fusion (ΔH_{f}), obtained from a second heating scan after the thermal history was removed on the first heating scan. The first heating scan was performed at a rate of 10° C./min, the subsequent cooling scan was performed at a rate of 10° C./min, and the following heating scan was performed at rate of 10° C./min. Decomposition temperatures (T_{d}, defined by the temperature of 5% weight loss) and maximum rate decomposition temperatures (Tₘₐₓ) of the polymers were measured by thermal gravimetric analysis (TGA) on polymer samples which were dried at ˜60° C. overnight on a Q50 TGA Analyzer, TA Instrument. Polymer samples were heated from ambient temperature to 700° C. at a heating rate of 10° C./min under N₂. Values of Tₘₐₓ were obtained from derivative (wt %/° C.) vs. temperature (° C.) plots, while T_{d} were obtained from wt % vs. temperature (° C.) plots.

Tensile Testing. Testing of sr-P3HB: Tensile stress/strain testing was performed in an Instron 5966 universal testing system (10 kN load cell) on three dog-bone-shaped test specimens (ASTM D638 standard; Type V). The specimens were prepared via compression molding using a Carver Auto Series Plus Laboratory Press (Carver, Model 3889.1PL1000, Max Force 15 ton) with programmable electrically heated platen (EHP) temperature, and air-/water-controlled cooling unless indicated otherwise. Isolated polymer materials were loaded between non-stick Teflon paper sheets into a stainless-steel mold with inset dimensions 30′ 73.5′ 0.41 mm fabricated in-house and compressed between the two EHPs at a clamp force of 5000 psi, at temperature ˜5° C. higher than each material's respective Tₘ for 10 min then the EHPs were turned off and the sample was left under pressure until it reached ambient temperature (slow cooling). Specimens for analysis were generated via compression molding and cut using an ASTM D638-5-IMP cutting die (Qualitest) to standard dimensions. From each compression molding procedure using the stainless-steel mold described, three ASTM D638-5 standard dog-bone shaped specimens could be cut. Mechanical behavior was averaged for all the specimens measured for each individual species investigated. Thickness (0.30˜0.50 mm), width (3.18 mm), and grip length (30.0 mm) of the measured dog-bone specimens were measured for normalization of data by the Bluehill measurement software (Instron). Test specimens were affixed into the screw-tight grip frame. Tensile stress and strain were measured to the point of material break at a grip extension speed of 5.0 mm min⁻¹ at ambient conditions. Young's modulus (E, MPa), ultimate strength (σ_{B}, MPa), yield strength (1 MPa), and elongation at break (ε_{B}, %) are obtained from the software analysis. Toughness values (U_{T}; MJ m⁻³) were obtained by manual calculation (integration) of the area under the stress/strain curve.

Tensile Testing. Testing of commercially available HDPE, LDPE, and it-PP: The detailed tensile testing results (individual stress/strain curves and tables) were previously reported (Li et al., Nat. Chem 2022, DOI: 10.1038/s41557-022-01077-x) and the values were taken from that paper for comparison while plotting overlay FIG. 3A in the main text). Film processing (melt compression molding) was performed for all polymers using a Carver Auto Series Plus Laboratory

Press (Carver, Model 3889.1PL1000, Max Force 15 ton) with programmable electrically heated platen (EHP) temperature, and air-/water-controlled cooling. Polymer samples prepared for film processing (3-5 g) were sandwiched between thin, non-stick Teflon sheets in a stainless-steel mold with inset dimensions 30×73.5×0.87 mm fabricated in-house and compressed between two 6″×6″ EHPs at a set pressure of 7000 psi for 30-60 min. LDPE samples were heated to 110° C. HDPE samples were heated to 150° C. It-PP samples were heated to 175° C. All samples were cooled in ˜10 minutes by air- and water-circulation attachments while under the 7 kpsi of compression. Tensile stress/strain tests were performed on ASTM D-638 Standard Type-V tensile bar (“dog-bones”; w=3.18 mm; t=0.5-1.0 mm) specimens on an Instron 5966 (TA Instruments) universal testing system equipped with a 10 kN load cell and operated at room temperature. Selected samples were tightly placed between textured grips, with a grip separation of ˜28 mm, and pulled at a constant strain-rate of 5 mm/min until break. Reported curves and values were averaged from 3-5 individual trials of each sample for reproducibility, and error margins are supplied accordingly. Force/displacement values were recorded and normalized to stress/strain by the Bluehill Universal Software (TA).

UV-Vis-NIR Optical Property Measurements. A Cary 5000 UV-vis NIR spectrophotometer from Agilent was used to measure the optical properties of thin films that were acquired by solvent casting from a suitable solvent. The films were cast in circular polypropylene petri dishes with a diameter of 4 in. Film thickness was measured to be 0.02+/−0.01 mm. Films were acquired by solvent casting from an appropriate solvent which was allowed to evaporate overnight, covered by a crystallization dish to allow for slow evaporation, before testing.

Biodegradation Measurements. Biodegradability of polymer samples in freshwater and soil environments was tested following ISO 14851 and ASTM 5988-18 protocols, respectively.

Freshwater Biodegradation Tests. Biodegradability tests in freshwater environment were conducted in triplicate using 300 mL biological oxygen demand (BOD) glass bottles (VWR International). In each BOD bottle, activated sludge (7.2 mg) from a wastewater treatment plant (Lemont, IL, USA) was mixed with 192.8 mL of aqueous medium comprising: KH₂PO₄, 85 mg/mL; K₂HPO₄, 217.5 mg/mL; Na₂HPO₄, 334 mg/mL; NH₄Cl, 15 mg/mL; MgSO₄·7H₂O, 22.5 mg/mL; CaCl₂·2H₂O, 36.4 mg/mL; and FeCl₃·6H₂O, 0.25 mg/mL. For each of the triplicate test bottles of polymer samples, 16.9 mg of each of the P3HB samples (sr-P3HB, (R)-P3HB, and bio-P3HB) was added to the BOD bottles, respectively. Three blank test bottles with no additional content as well as three positive control bottles with 23.2 mg of D-glucose (Fisher Scientific, granular powder) were also tested. These all were incubated in a New Brunswick Scientific incubator shaker (Eppendorf, model 1-24) at 25° C. for 90 days. BOD values were determined by measuring oxygen consumption using Thermos Scientific pH/RDO/DO meter (Thermo Fisher Scientific, model Orion Star A216) based on ISO 14851 standard method. The biodegradability of the sample in percentage was calculated as [(BODₛₐₘₚₗₑ−BOD_{blank})/(C×ThOD)]×100. BODₛₐₘₚₗₑ and BOD_{blank} are the observed values of the sample and blank bioreactor, respectively, c is the mass of sample added (mg), and ThOD is the theoretical oxygen demand value of the sample, calculated from the chemical formula and based on the assumption of complete oxidation of polymer sample.

Soil Biodegradation Tests. Biodegradability tests in soil environment (soil respiration tests) were conducted in triplicate. The biodegradability of samples was monitored up to 90 days. The soil respiration tests were set up in 1 L Kimble bottles capped with Wheaton Black Phenolic Cap (with Gray Butyl Septa and Flange, DWK Life Sciences). Each test bottle contained 150 g of soil (mixture of soil from local forests in Illinois). To each test bottle, 41.8 mL of water was added to reach the 46.5% field capacity. The field capacity (water holding capacity) of soil was measured using ASTM D2980-17E01 method. For each of the triplicate test bottles of polymer samples, 0.538 g of each of the P3HB samples (sr-P3HB, (R)-P3HB, and bio-P3HB) was added to the BOD bottles, respectively and well mixed with the soil. Three blank test bottles with no additional content as well as three positive reference bottles with 0.675 g of cellulose (microcrystalline, particle size 0.05 mm, Acros Organics) were also set up. The degradation of the polymers was monitored by measuring the CO₂ volume released into the headspace of the bottles. Samples collected from the headspace were analyzed by a gas chromatography (Shimadzu, model GC-2014). Biodegradation of polymers in percentage is calculated as (V_{CO2, sample}−V_{CO2, blank})/ThV_{CO2, sample}×100, ThV_{CO2, sample} is the theoretical production volume of CO₂ calculated from the mass of carbon in polymer samples.

Estimation of End of Lifetime. First order kinetic model % Biodegradation=1−exp(−k×time+C) is used to plot the percentage biodegradation vs time. From the equation, k is the rate constant, and C is a constant from the plot. A summary of rate constant and estimated time to reach 90% biodegradation and R² values was recorded.

Successive Self-nucleation and Annealing (SSA). SSA is a thermal fractionation technique that is performed using a Differential Scanning calorimetry (DSC) to study the different molecular segregation capacity that, normally, the semicrystalline polymeric systems exhibit after isothermal crystallization and annealing processes (Müller et al., Eur. Polym. J. 2015, 65, 132-154). The many different purposes of the SSA technique are amply shown and described by Perez-Camargo et al. (Front. Soft Matter 2022, 2). The SSA experiments were carried out following the protocol defined by Muller et al. (Eur. Polym. 1 2015, 65, 132-154; Prog. Polym. Sci. 2005, 30, 10 559-603). The first heating scan is the one in which the thermal history of the sample is erased (heating the sample 20° C. above the melting point and maintaining that temperature for 3 minutes). For this work, during the second step the samples were cooled down to −20° C. After 1 min at this temperature, the sample is heated to a temperature of 7.5° C. lower than the end-temperature melting (as a proxy of the ideal self-nucleation temperature) and kept for 3 min at that temperature. Subsequently, the sample was cooled again to −20° C. and held at this temperature for 1 min. This cyclic process was repeated by varying the Tₛᵢ 10 times, decreasing it at each cycle by 7.5° C. Finally, the sample was heated to the molten state (200° C. in this case) to observe the results of the thermal fractionation, reported in FIG. 2.

All the scans were performed at 20° C./min in a Perkin Elmer DSC 8500 with an Intracooler III as a cooling system. This equipment was calibrated using indium and tin as standards. For comparative purposes, this experiment was also performed on bio-PHB (Sigma-Aldrich).

Small Molecule Syntheses. The synthesis of meso-8DL^{Me} was carried out following literature procedure (Tang et al., Science 2019, 366 (6466), 754-758) with the modification made to the synthesis of intermediate dimethyl 1,4-dimethyl-2,5-dioxocyclohexane-1,4-dicarboxylate, which was supplemented here.

Synthesis of dimethyl 1,4-dimethyl-2,5-dioxocyclohexane-1,4-dicarboxylate. A solution of dimethyl 2,5-dioxocyclohexane-1,4-dicarboxylate (70.0 g, 0.31 mol) and K₂CO₃ (127.3 g, 0.9 mol) in acetone (˜1 L) was stirred under N₂ for 15 min. MeI (174.2 g, 1.2 mol) was then added dropwise and the temperature was increased to 60° C. (reflux). After 18 h, the acetone was concentrated in vacuo, the solid obtained was dissolved in H₂O (˜700 mL) and extracted with CH₂Cl₂ (350 mL×5). The combined organic layers were washed with 10% Na₂S₂O₃ solution (˜1 L), dried with anhydrous Na₂SO₄, and concentrated to give 68.9 g (88%) in a ratio of 54:46 (rac:meso) mixture of diastereomers.

Typical polymerization procedure. Polymerizations were performed in 7.0 mL glass reactors inside an inert N₂ glovebox at ambient temperature (˜23° C.). The reactor was charged with a predetermined amount of monomer (meso-8DL^{Me}) and solvent in the glovebox, and a mixture of catalyst and/or initiator in solvent was stirred at ambient temperature for 10 min in another reactor. Polymerization was initiated by rapid addition of the catalyst solution to the monomer solution. After a desired time, a 0.01 mL of aliquot was taken from the reaction mixture and quenched with a 5% solution of benzoic acid in CDCl₃ for ¹H NMR analysis to obtain the percent monomer conversion data. The polymerization was then immediately quenched by addition of ˜5 mL of HCl/chloroform (5% solution). The quenched mixture was then precipitated into an excess amount of cold methanol while stirring, filtered, washed with cold methanol to remove any unreacted monomer, and dried in a vacuum oven at 60° C. overnight to a constant weight.

### Example 1. Poly(3-hydroxybutyrate) (P3HB) Adhesives

Polyhydroxyalkanoates (PHAs) have attracted enormous interest in industry and academia due to their facile biodegradability and biocompatibility, among which, poly(3-hydroxybutyrate) (P3HB) is the most intensively investigated. P3HB has thermal and mechanical properties resembling those of polyolefins, and thus holds great promise as future commodity plastics with beneficial end-of-life options. Nowadays, most studies on P3HB are limited to traditional mechanical performance elevation through structural manipulation for potential use as packaging materials. To advance the advantages of this type of biodegradable polymers, other application areas of P3HB need to be further explored and expanded. As a prototypical polyester, P3HB is largely composed of ester groups, which could render it as a good adhesive material on metal, wood, and glass ascribed to the physical interactions between metal and oxygen atoms or from hydrogen bonds. Additionally, the viscoelastic properties of P3HB can be conveniently and effectively tuned by modulating its stereomicrostructures enabled by catalyst and monomer selection, which will further benefit its adhesive behaviors.

To set out, we first synthesized stereomicrostructurally diverse P3HBs from eight-membered dimethyl diolides (8DL^{Me}) with mm triad values ranging from >99% to 0%, offering isotactic (it-), iso-rich (ir-), atactic (at-), and syndio-rich (sr-) P3HBs as shown in Table 1.1. By tuning the tacticities, the resulting polymers span from being completely amorphous to semicrystalline, and eventually to highly crystalline, offering a broad degree of crystallinities (X_{c}) and melting transition temperatures (Tₘ) from 0% to 67% and 78° C. to 172° C. (Table 1.1), respectively.

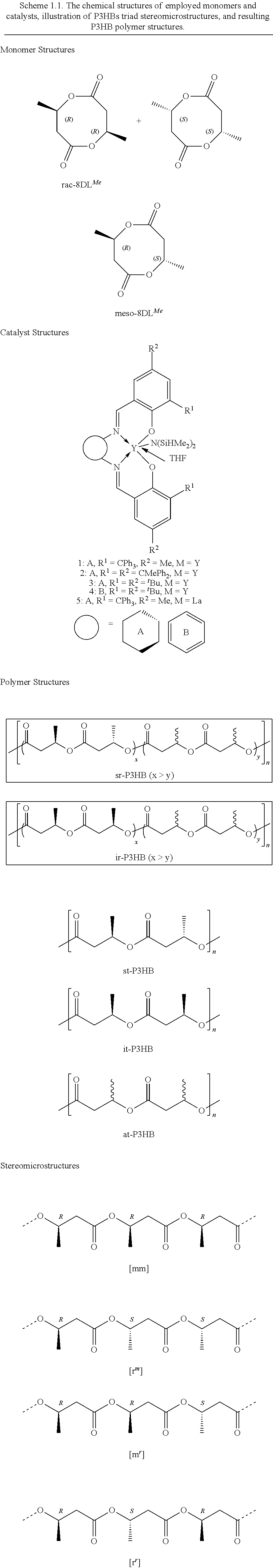

TABLE 1.1
Synthesis and properties of stereomicrostructurally engineered P3HBs from 8DL^{Me}. ^{a}

| | | | Mₙ ^{b} | | Tₘ | X_{c} | [mm] ^{c} | [mr] + | [rr] ^{c} | | |
|---|---|---|---|---|---|---|---|---|---|---|---|
| Entry | [M] | Cat. | (kDa) | Ð ^{b} | (° C.) | (%) | (%) | [rm] ^{c} (%) | (%) | Pm ^{c} | P3HB |
| 1 | rac- | 1 | 75.8 | 1.29 | 172 | 67 | >99 | 0 | 0 | >0.99 | it-/ir- |
| 2 | 8DL^{Me} | 2 | 40.3 | 1.10 | 155 | 45 | 93 | 7 | 0 | 0.96 | P3HB |
| 3 | | 3 | 67.5 | 1.20 | 141 | 27 | 87 | 13 | 0 | 0.94 | |
| 4 | | 4 | 56.9 | 1.02 | 108 ^{d} | 18 | 80 | 20 | 0 | 0.90 | |
| 5 | rac + meso | 4 | 105 | 1.16 | — ^{e} | 0 | 24 | 44 | 32 | 0.56 | at- |
| | (40:60) | | | | | | | | | | P3HB |
| 6 | meso- | 3 | 136 | 1.47 | 78 ^{d} | 26 | 0 | 58 | 42 | 0.29 | sr- |
| 7 | 8DL^{Me} | 2 | 120 | 1.31 | 105 ^{d} | 30 | 0 | 48 | 52 | 0.24 | P3HB |
| 8 | | 1 | 38.1 | 1.01 | 140 ^{d} | 34 | 0 | 34 | 66 | 0.17 | |
| 9 | | 5 | 75.0 | 1.06 | 169 | 45 | 0 | 16 | 84 | 0.08 | |

^{a} Reaction conditions (unless stated otherwise): [M] = 1.0M, dichloromethane (DCM), benzyl alcohol (BnOH) as initiator, ~25° C.
^{b} Number-average molar mass (Mₙ) and dispersity (Ð = M_{w}/Mₙ) determined by size exclusion chromatography (SEC) coupled with a Wyatt DAWN HELEOS II multi (18) angle light scattering detector and a Wyatt Optilab TrEX dRI detector and performed at 40° C. in chloroform.
^{c} Calculated from ¹³C NMR spectrum (CDCl₃, 23° C.).
^{d} Data collected from the first heating scan, while all others from the second heating scan.
^{e} No Tₘ.

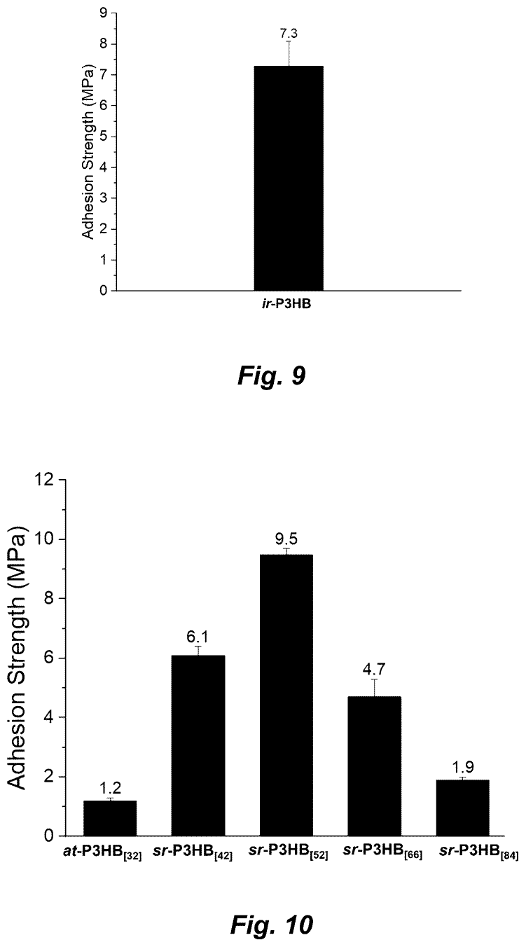

The P3HB materials were then subjected to lap-shear test. The results showed that it- and ir-P3HBs all possessed poor adhesion on aluminum substrate, leading to unsuccessful tests. However, the it-P3HB produced by complex 4 (Table 1.1, Entry 4) displayed high adhesive strength (>7.3 1MPa) on glass substrate (FIG. 9), which is stronger than the strength of the substrate and led to broken glass. We then tested at-P3HB, an amorphous material without any crystalline domains, and found it displayed a moderate adhesive strength of 1.2 MPa along with a cohesive failure (Table 1.1, Entry 5; FIG. 10). In contrast, sr-P3HB_{[xx]} ([xx] denotes rr triad values as indicated in Table 1.1) with various tacticities all displayed moderate to high adhesive strength up to 9.5 MPa on aluminum substrates (FIG. 10).

Interestingly, with the increase of the tacticity, the polymers first experienced an increase in adhesive strength from 6.1 MPa for sr-P3HB_{[42]} to 9.5 MPa for sr-P3HB_{[52]}, and then a gradual drop to 4.7 MPa and 1.9 MPa for sr-P3HB_{[66]} and sr-P3HB_{[84]}, respectively. The observed high adhesive strength of sr-P3HBs, especially for sr-P3HB_{[52]}, is likely contributed by the synergistic combination of a suitable level of crystallinity that endows the polymer with good mechanical toughness, amorphous domains that offer the polymer liquid character to form intimate contact with the metal surface, and the ester groups (oxygen atoms) which provide the physical interactions between the polymer and the substrate. However, the same principle seems not apply to ir-P3HBs, such as the ir-P3HB produced by complex 4 (Table 1.1, entry 4) which possesses a suitable amount of both crystalline and amorphous domains but did not display any adhesion to aluminum substrates. This distinct adhesive performance is likely caused by the stereomicrostructure difference between ir- and sr-P3HBs.

Next, the effect of molar mass on the adhesion performance was evaluated by synthesizing sr-P3HB with various Mₙ from 14.1 kDa to 182 kDa (Table 1.2). It was found that the sr-P3HBs

all displayed similar adhesive strength from 5.3 MPa to 6.1 MPa on aluminum substrate, indicating that the molar mass does not have a significant impact on the adhesive performance of the polymer.

Notably, the sr-P3HB_{[42]} with a low Mₙ of 14 kDa showed cohesive failure type during the lap-shear test, which contrasts with that of the polymer with higher molar mass and was caused by the reduced molecular entanglement, and thereby decreased mechanical toughness. This observation is indeed beneficial in practical applications where specific failure type is required under different scenarios.

TABLE 1.2
Adhesive performance of sr-P3HB_{[42]} with various molar mass.

| | | | | | Adhesive | |
|---|---|---|---|---|---|---|
| | | Mₙ | Ð | | strength | Failure |
| Entry | Catalyst | (kDa) | (M_{w}/Mₙ) | Substrate | (MPa) | type |
| 1 | 3 | 182 | 1.20 | Al | 6.1 ± 0.3 | adhesive |
| 2 | 3 | 136 | 1.47 | Al | 5.5 ± 0.4 | adhesive |
| 3 | 3 | 97.3 | 1.12 | Al | 5.3 ± 0.1 | adhesive |
| 4 | 3 | 14.1 | 1.10 | Al | 5.5 ± 0.1 | cohesive |

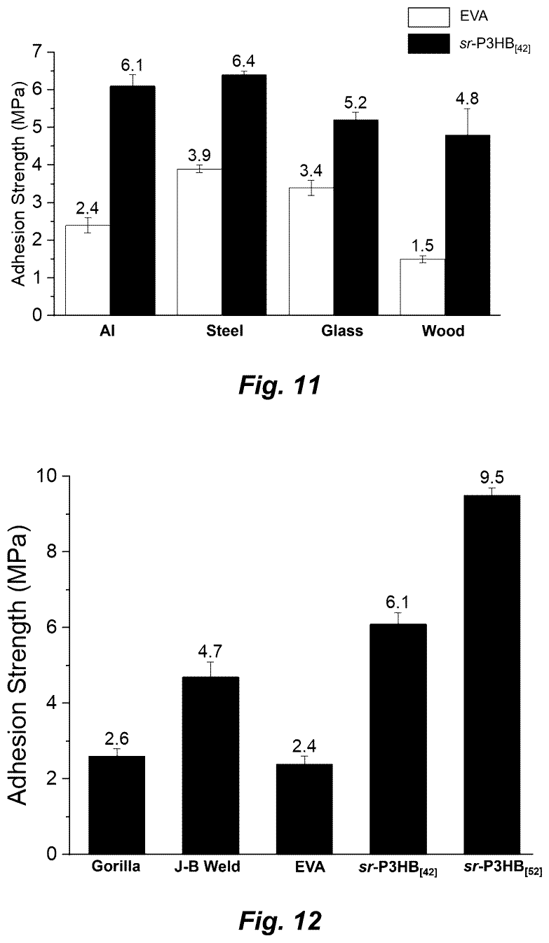

To evaluate the universality of the adhesive performance, lap-shear tests of sr-P3HB_{[42]} were performed on various substrates, including aluminum, steel, glass, and wood (FIG. 11). The polymer displayed a similar adhesive strength of 6.1˜6.4 MPa on both aluminum and steel surfaces.

On glass substrate, the adhesive strength of sr-P3HB_{[42]} is higher than the strength of the glass used, and thus led to the glass breaking. Besides the metal and glass substates, sr-P3HB_{[42]} also

showed strong adhesion on natural materials. For example, an adhesive strength of 4.8 MPa was

observed on the wood substrate. The universal high adhesive strength of sr-P3HB_{[42]} highlights its broad application window which could help many industries create more sustainable products.

For comparison, the adhesive performance of the widely used commercial ethylene-vinyl acetate (EVA) hot melt was also evaluated under identical conditions. It was found EVA displayed inferior performance on all tested substrates relative to sr-P3HB_{[42]}. This study demonstrated sr-P3HB holds great promise to be a bio-sourced and biodegradable substituent of petroleum-based non-degradable EVA hot melt.

Adhesive strength of other widely used commercial glues, such as Gorilla® super glue and J-B Weld® adhesive were also evaluated for comparison purposes. The results showed that both sr-P3HB_{[42]} and sr-P3HB_{[52]} with adhesive strength of 6.1 MPa and 9.5 MPa, respectively, out-performed all the tested commercial glues which showed adhesive strength less than 5 MPa on aluminum substrate (FIG. 12). Overall, this study demonstrated the superior adhesive strength of biodegradable P3HB materials to the conventional non-degradable commercial glues and highlighted their great potential as a new type of adhesive.

The synthesis of stereomicrostructurally diverse P3HBs from β-butyrolactone (BBL) was carried out as shown in Table 1.3 and FIG. 13. The obtained polymers were then subjected to lap-shear testing on aluminum substrates. It was found both ir-P3HB_{BBL} and st-P3HB_{BBL} did not display any adhesion on aluminum, like the previous results. Weak adhesive strength was found for at-P3HB_{BBL} due to its amorphous nature (FIG. 14). Consistent with the adhesion results obtained from 8DL^{Me}-produced sr-P3HBs, the sr-P3HB_{BBL} displayed excellent adhesive strength of 6.2 MPa, which is higher than the evaluated commercial glues.

TABLE 1.3
Synthesis and properties of stereomicrostructurally engineered P3HBs from BBL.

| | | | | | | | | [mr] + | | | |
|---|---|---|---|---|---|---|---|---|---|---|---|
| | | | Mₙ | | Tm | X_{c} | [mm] | [rm] | [rr] | | |
| Entry | [M] | Cat. | (kDa)^{e} | Ð^{e} | (° C.)^{f} | (%)^{f} | (%)^{g} | (%)^{g} | (%)^{g} | Pₘ^{g} | P3HB |
| 1^{a} | BBL | 6 | 155 | 1.27 | 140 | 27 | 78 | 15 | 7 | 0.86 | ir-P3HB_{BBL} |
| 2^{b} | | 7 | 37.3 | 1.13 | 94 | 0.4 | 25 | 51 | 24 | 0.50 | at-P3HB_{BBL} |
| 3^{c} | | 8 | 40.6 | 1.07 | 135 | 32 | 5 | 34 | 61 | 0.22 | sr-P3HB_{BBL} |
| 4^{d} | | 9 | 227 | 1.43 | 176 | 51 | <1% | 12 | 87 | 0.06 | st-P3HB_{BBL} |

^{a}Reaction conditions: [M] = 2.0M, toluene (tol), ~25° C.
^{b}Reaction conditions: neat, 60° C.
^{c}Reaction conditions: [M] = 2.0M, tol, isopropyl alcohol as initiator, ~25° C.
^{d}Reaction conditions: [M] = 2.0M, tol, ~25° C.
^{e}Number-average molar mass (Mₙ) and dispersity (Ð = M_{w}/Mₙ) determined by size exclusion chromatography (SEC) coupled with a Wyatt DAWN HELEOS II multi (18) angle light scattering detector and a Wyatt Optilab TrEX dRI detector and performed at 40° C. in chloroform.
^{f}Data collected from second heating scan.
^{g}Calculated from ¹³C NMR spectrum (CDCl₃, 23° C.).

In practical application, the mechanical properties of adhesives are also critical to withstand damage throughout their application lifespan. Therefore, the tensile performance of sr-P3HB_{[42]}

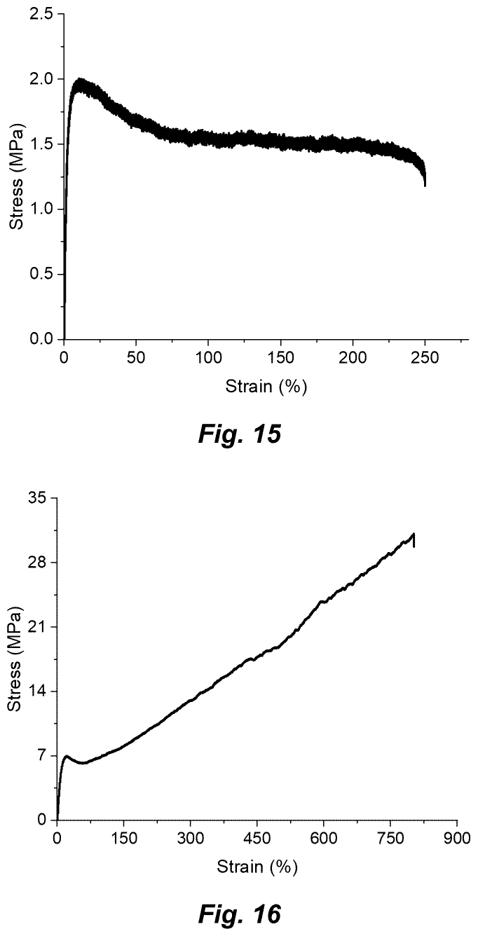

was evaluated against EVA hot melts. As a thermoplastic, EVA was found to be a weak material showing a low stress of less than 2.0 MPa and moderate extensibility of 250% (FIG. 15).

However, sr-P3HB_{[42]}, as a biodegradable thermoplastic, exhibited much higher tensile stress over 30 MPa and elongation at break approaching 900% (FIG. 16), further highlighting the overall superior properties of our P3HB materials.

### Experimental Procedures.

Lap shear measurements for Al, steel, glass, and wood substrates were conducted following a modified version of the ASTM D1002 method in an Instron 5966 universal testing system (10 kN load cell) at a crosshead speed rate of 5 mm min⁻¹. Specimens were created by heating the desired P3HB between two substrates while applying pressure with small binder clips and annealing them in a vacuum oven at 60° C. overnight. The specimens were then cooled to ˜25° C. and their adhesive strength was then tested.

P3HBs from 8DL^{Me} were synthesized according to the following general procedure. In an inert (N₂) glovebox a predetermined amount of catalyst and initiator were added to a glass reactor with dichloromethane (DCM) and stirred for ˜10 min then rapidly added to 8DL^{Me} which was dissolved in DCM in another glass reactor. After an amount of time an aliquot of the reaction mixture was taken to determine monomer conversion then the reaction was quenched with acidified methanol (5% HCl). The polymer was then isolated, reprecipitated and isolated again then dried in a vacuum oven at 60° C. overnight.

P3HBs from BBL were synthesized according to the following procedures.

For P3HB from Table 1.3, Entry 1 catalyst components were dissolved in toluene and stirred for two hours in a glass reactor then BBL was rapidly injected in an inert (N₂) glovebox. After an amount of time an aliquot of the reaction mixture was taken to determine monomer conversion then the reaction was quenched with acidified methanol (5% HCl). The polymer was then isolated, reprecipitated and isolated again then dried in a vacuum oven at 60° C. overnight.

For P3HB from Table 1.3, Entry 2 BBL and catalyst were added to a glass reactor in an inert (N₂) glovebox and sealed then heated and stirred outside of the glovebox. After an amount of time an aliquot of the reaction mixture was taken to determine monomer conversion then the reaction was quenched with acidified methanol (5% HCl). The polymer was then isolated, reprecipitated and isolated again then dried in a vacuum oven at 60° C. overnight.

For P3HB from Table 1.3, Entry 3 in an inert (N₂) glovebox a predetermined amount of catalyst and initiator were added to a glass reactor with toluene and stirred for ˜10 min then BBL was rapidly added. After an amount of time an aliquot of the reaction mixture was taken to determine monomer conversion then the reaction was quenched with acidified methanol (5% HCl). The polymer was then isolated, reprecipitated and isolated again then dried in a vacuum oven at 60° C. overnight.

For P3HB from Table 1.3, Entry 4 in an inert (N₂) glovebox catalyst was dissolved in toluene in a glass reactor and BBL was rapidly added. After an amount of time an aliquot of the reaction mixture was taken to determine monomer conversion then the reaction was quenched with acidified methanol (5% HCl). The polymer was then isolated, reprecipitated and isolated again then dried in a vacuum oven at 60° C. overnight.

### Example 2. High-performance syndio-rich and iso-rich P3HB and Use for toughening brittle biological or synthetic P3HB

Poly(3-hydroxybutyrate) (P3HB), a biologically produced, biodegradable natural polyester, exhibits excellent thermal and barrier properties but suffers from mechanical brittleness, largely limiting its applications. Here we report a mono-material product design strategy to substantially toughen stereoperfect, brittle bio or synthetic P3HB by blending it with a stereomicrostructurally engineered P3HB. Specifically, through tacticity and molecular weight tuning, high-performance synthetic P3HB materials with Mₙ to 788 kDa, tensile strength to ˜30 MPa, fracture strain to ˜800%, and toughness to 135 MJ m⁻³ (>120 times tougher than bio-P3HB) have been produced. Physical blending of the brittle P3HB with such P3HB in 10 to 90 wt. % dramatically enhances its ductility from ˜5% to 95-450%, while maintaining desirably high elastic modulus (>1 GPa), tensile strength (>35 MPa), and melting temperature (160-170° C.). This P3HB-toughening-P3HB methodology departs from the traditional approach of incorporating chemically distinct components to toughen P3HB, which hinders chemical or mechanical recycling, highlighting the potential of the mono-material product design solely based on biodegradable P3HB to deliver P3HB materials with diverse performance properties.

Poly(3-hydroxybutyrate) (P3HB) is the most prominent member of the large polyhydroxyalkanoate (PHA) family. It is a biologically produced natural polyester and biodegradable in freshwater and soil under ambient conditions and thus has long been considered a promising sustainable alternative to petroleum-based and/or non-biodegradable plastics. Biological P3HB, a stereoperfect (sp-P3HB_{b}), purely isotactic aliphatic polyester with an absolute (R)-stereoconfiguration, exhibits high crystallinity and melting temperature (Tₘ, 170-180° C.), as well as excellent barrier properties, but it is extremely brittle with elongation at break (en) of only 2-5%.⁹⁻¹² In comparison, chemosynthetic routes offer facile tunability in PHA stereomicrostructures (tacticities) and potential advantages in production scalability and speed.¹³

Early work on synthetic P3HB was focused on developing synthetic methodologies that could rival the natural process to afford bio-equivalent, stereoperfect synthetic P3HB (sp-P3HBₛ). The most studied synthetic route to P3HB is the ring-opening polymerization (ROP) of racemic β-butyrolactone (rac-BBL),¹³⁻¹⁶ affording iso-rich P3HB (ir-P3HB) with isotacticity (defined here as percent meso triad [mm]) <80% and Pₘ (the probability of meso linkages between monomer units) up to 0.89.¹⁶-18 The recently developed chemocatalytic ROP of the bio-derived eight-membered racemic dimethyl diolide (rac-8DL^{Me}) successfully achieved that challenging goal of producing sp-P3HBs with isotacticity [mm]>99%, Pₘ>0.99, and Tₘ up to 175° C. 19 As expected, sp-P3HBₛ is as brittle as sp-P3HB_{b}, but tuning the tacticity to syndio-rich sr-P3HB ([rr]=53%, Pᵣ=0.77) resulted in impressive ε_{B} (419%), high ultimate tensile strength (σ_{B}=34 MPa), and excellent toughness (U_{T}=96 MJ m⁻³).²⁰

A combined successive self-nucleation and annealing (SSA) thermal fractionation and polarized light optical microscopy (PLOM) study showed that the observed high optical transparency and ductility, despite being semicrystalline, is due to a sub-microspherulitic morphology resulted from enhanced nucleation and interrupted crystallizable sequences by the randomly distributed stereo-defects along the P3HB chain. Later, it-P3HB ([mm]=74%, Pₘ=0.84) obtained from the ROP of rac-BBL also showed high ε_{B} to 392% but reduced σ_{B} to 21 MPa.¹⁷

Modulating polymer tacticities is an effective method to tune thermal and mechanical properties of polymers including PHAs.^{13,21,25} In this context, ductile P3HB materials such as ir- and sr-P3HBs can be made by lowering the stereoregularity and thus the degree of crystallinity,^{17,20,26,27} but are often challenged by property trade-offs with reduced Tₘ, yield stress (σ_{y}), and elastic modulus (E). Various degrees of P3HB toughening were also achieved via copolymerization^{28,29} and physical blending³⁰⁻³³ with more flexible components, but this approach increases materials' heterogeneity and complicates recycling. Blending sp-P3HB_{b} with atactic (at-) and sr-P3HBs was also examined, but only limited success was achieved and property trade-offs were pervasive.²⁸⁻²⁹ For example, a 30:70 sp-P3HB_{b}/at-P3HB blend improved the ductility from 2% to 50% but also drastically decreased E from 3.35 GPa to 0.17 GPa and as by 90%,²⁹ because the amorphous at-P3HB decreases the overall crystallinity and contributes only to the amorphous regions between individual lamellae of sp-P3HB_{b}.³⁰

Overall, the unmet critical challenge here is how to toughen the brittle sp-P3HB without compromising its other superior thermomechanical properties through simple blending with a stereomicrostructurally engineered P3HB so that it also observes the mono-material product design principle.³⁴ Meeting this challenge is the central objective of this work, and the results reported here showed this can indeed be achieved through blending, but synthetic P3HB with a specific stereomicrostructure is needed to achieve synergistic toughening effects.

TABLE 2.1
P3HB materials with a spectrum of stereomicrostructures employed for systematic
blending studiesª
Monomer Structures

| | |
|---|---|
| rac-8DL^{Me} | 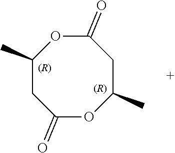 |
| | 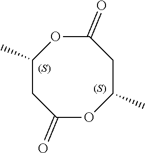 |
| meso-8DL^{Me} | 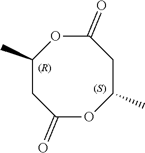 |
| rac-BBL | 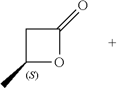 |
| | 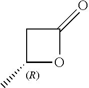 |

Catalyst Structures

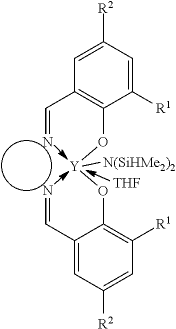

1: A, R¹ = CPh₃, R² = Me
2: A, R¹ = R² = CMePh₂
3: A, R¹ = R² = ^{t}Bu
4: B, R¹ = R² = ^{t}Bu

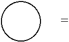

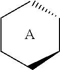

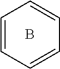

Stereomicrostructures

| [mm] | | 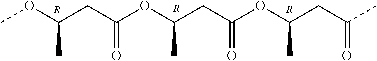 | | | | | | |
|---|---|---|---|---|---|---|---|---|
| [rm] | | 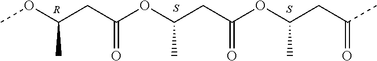 | | | | | | |
| [mr] | | 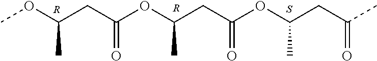 | | | | | | |
| [rr] | | 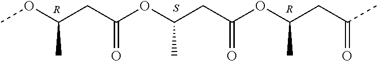 | | | | | | |
| P3HB Tacticities | | [mm] (%) | | | | | | |
| sp-P3HB_{b} | | >99% | | | | | | |
| sp-P3HBₛ | | >99% | | | | | | |
| it-P3HB | | >85% | | | | | | |
| ir-P3HB | | >60% | | | | | | |
| at-P3HB | | 60-40% | | | | | | |
| sr-P3HB | | <40% | | | | | | |
| st-P3HB | | <15% | | | | | | |
| | | Mₙ | | | [mr] + [rm] | [rr] | | P3HB |
| Entry | [M] (cat) | (kDa)^{e} | Ð^{e} | [mm] (%)^{f} | (%)^{f} | (%)^{f} | Pₘ^{f} | definition |
| 1 | (bio) | 379 | 2.02 | >99 | 0 | 0 | >0.99 | sp-P3HB_{b} |
| | rac-8DL^{Me} | | | | | | | |
| 2 | (1) | 290 | 1.02 | >99 | 0 | 0 | >0.99 | sp-P3HBₛ |
| | rac-8DL^{Me} | | | | | | | |
| 3 | (2) | 216 | 1.18 | 93 | 7 | 0 | 0.96 | it-P3HB |
| | rac-8DL^{Me} | | | | | | | |
| 4 | (4) | 106 | 1.04 | 80 | 20 | 0 | 0.90 | ir-P3HB₁₀₆ₖ |
| | rac-8DL^{Me} | | | | | | | |
| 5 | (4) | 788 | 1.19 | 82 | 18 | 0 | 0.91 | ir-P3HB₇₈₈ₖ |
| 6 | rac-BBL(^{b}) | 240 | 1.83 | 74 | 20 | 6 | 0.84 | ir-P3HB_{BBL} |
| 7 | meso- | 260 | 1.24 | 0 | 57 | 43 | 0.29 | sr-P3HB |
| | 8DL^{Me} (3) | | | | | | | |
| 8 | 8DL^{Me} (4^{c}) | 147 | 1.10 | 33 | 26 | 41 | 0.54 | at-P3HB |
| 9 | meso- | 67.1 | 1.05 | 0 | 23 | 77 | 0.11 | st-P3HB |
| | 8DL^{Me} (1^{d}) | | | | | | | |

^{a}Reaction conditions (unless stated otherwise): [M] = 1.0M, dichloromethane (DCM), benzyl alcohol (BnOH) as initiator, ~25° C.
^{b}Carried out according to literature procedures.¹⁷
^{c}8DL^{Me} = 2.50 g (14.5 mmol, 50:50 ratio of rac:meso) in DCM, 1.50M.
^{d}Carried out according to literature procedures.²⁰
^{e}Absolute weight-average molar mass (M_{w}), number-average molar mass (Mₙ), and dispersity (Ð = M_{w}/Mₙ) determined by size exclusion chromatography (SEC) coupled with a Wyatt DAWN HELEOS II multi (18) angle light scattering detector and a Wyatt Optilab TrEX dRI detector and performed at 40° C. in chloroform.
^{f}Calculated from ¹³C NMR spectrum (CDCl₃, 23° C.).

To systematically investigate the effectiveness of toughening sp-P3HB_{b} with synthetic P3HBs of tailored tacticities, P3HBs with diverse stereomicrostructures (sp, it, ir, sr, at, and st) were synthesized in accordance with the stereomicrostructural engineering platform enabled by 8DL^{Me} containing two stereogenic centers and discrete yttrium salen complexes 1-4 as outlined in Table 2.1. These polymerizations successfully produced various P3HBs with Mₙ from 67 to 788 kDa and low dispersity (1.02 to 1.24) at high to quantitative monomer conversions, offering P3HBs with Pₘ values from 0.11 to >0.99, [mm] from 0 to >99%, [rr] from 0 to 77%, and [mr]+[rm] from 0 to 57%. It is worth noting the different stereomicrostructures of the P3HBs obtained from rac-8DL^{Me} and rac-BBL (ir-P3HB_{BB}L) (Table 2.1, Entries 2-6) as the P3HB from rac-8DL^{Me} does not contain any highly crystallizable [rr] triads. It should be noted that, when choosing candidates for blending, we excluded blending brittle sp-P3HB with other brittle materials, which include it-P3HB and st-P3HB.

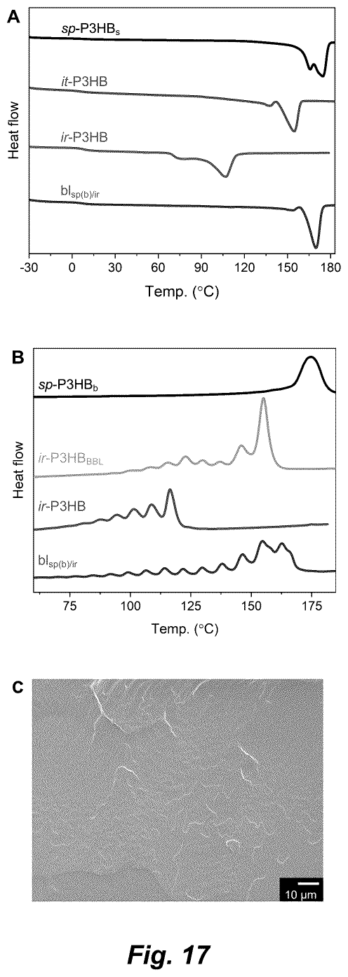

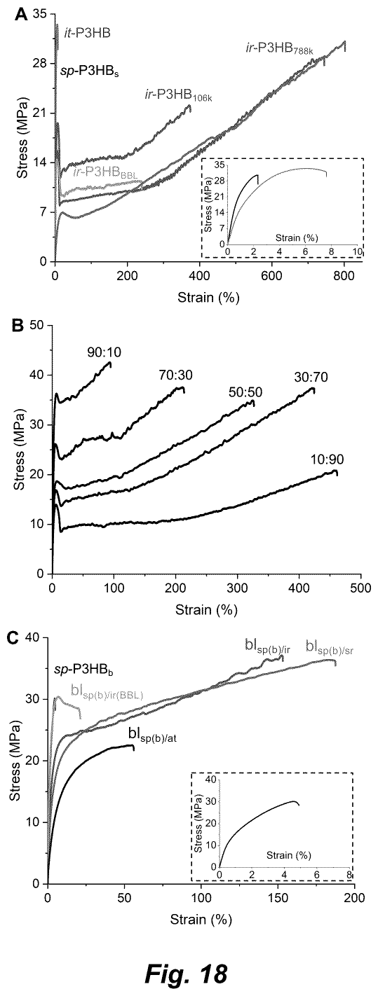

With these stereomicrostructurally engineered P3HBs synthesized, thermal, morphological, optical, and mechanical properties of the P3HBs before and after the blending were studied and compared, aiming to illustrate the relationship between the backbone tacticity and materials properties (Tables 2.1-2.2; FIGS. 17-18). As expected, with a decrease in isotacticity from [mm]>99% to 82%, the P3HB experienced a gradually reduced Tₘ from 172° C. for sp-P3HBs to 155° C. for it-P3HB and eventually to 108° C. for ir-P3HB₇₈₈ₖ, accompanied by a simultaneous drop in heat of fusion (ΔH_{f}) from 97.5 J g⁻¹ to 25.4 J g⁻¹, therefore in crystallinity from 67% to 17%. SSA thermal fractionation of sp-P3HB_{b} (FIG. 17B) showed only one fraction peak corresponding to its purely isotactic structure, while ir-P3HB₇₈₈ₖ was fractionated into well-defined evenly distributed thermal fractions, attributed to the randomly installed stereodefects that frequently disrupt the long stereoregular, crystallizable sequences, behaving similarly to sr-P3HB.²⁰

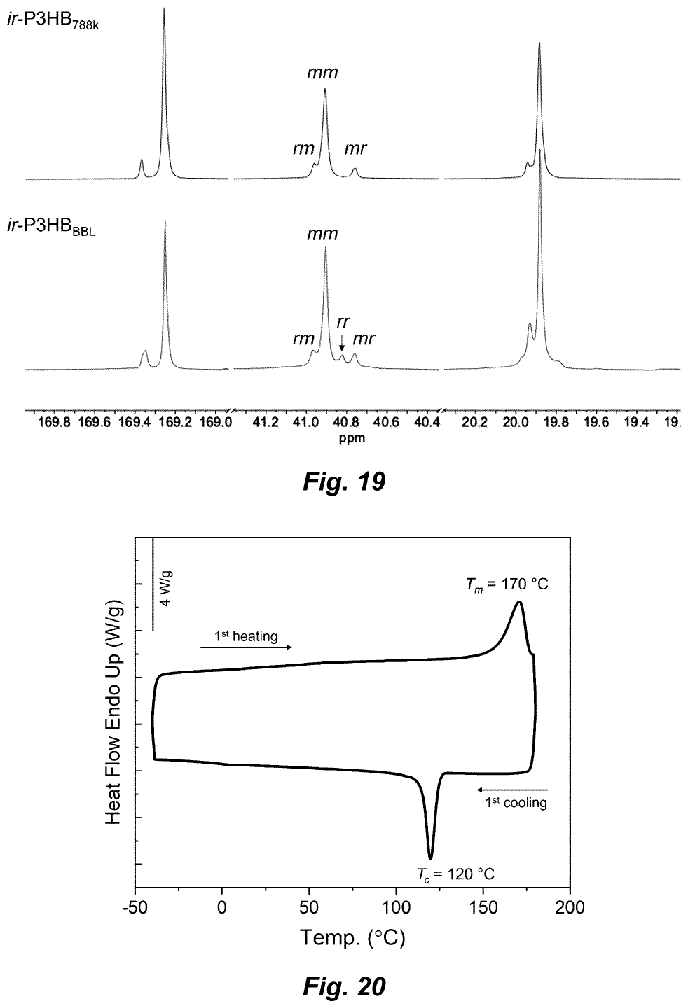

In contrast, ir-P3HB_{BBL} was found to fractionate into many unevenly distributed fractions, featuring a bimodal distribution of stereodefects (high and low contents of the defects at low and high temperature fractions) that interrupt the crystallizable sequences. The sharp difference in the thermal fractions between the two it-P3HBs obtained from rac-8DL^{Me} and rac-BBL is likely caused by the heterogeneity of ir-P3HB_{BBL}, as indicated by its multiple sets of end-groups¹⁷ and the stereomicrostructure that contains 7% [rr], while the it-P3HB obtained from rac-8DL^{Me} does not possess any [rr], despite the similar Pₘ values (FIG. 19; Table 2.1). This intriguing result also highlights the importance of examining the stereomicrostructures beyond the commonly used diads (Pₘ or Pᵣ) to triads, or pentads if possible, when comparing materials properties of stereoisomeric polymers in general, including P3HBs involved in this study.

Moving to the P3HB blends, due to the identical chemical nature, b1_{sp/ir}, the blends comprising sp-P3HBₛ or sp-P3HB_{b} and ir-P3HB₇₈₈ₖ in various weight ratios displayed one Tₘ peak at ˜170° C. on both 1s t and 2n d heating scans (FIGS. 17A, 20-21), indicating the formation of miscible blends between the individual components. This blend can be thermally fractionated into many smaller fractions from 75° C. to 175° C., indicating that the incorporation of ir-P3HB₇₈₈ₖ successfully disrupted the strong crystallization tendency of sp-P3HB_{b}. The miscibility was further evidenced by comparing the SSA curves of the theoretically immiscible blend with the experimentally observed.

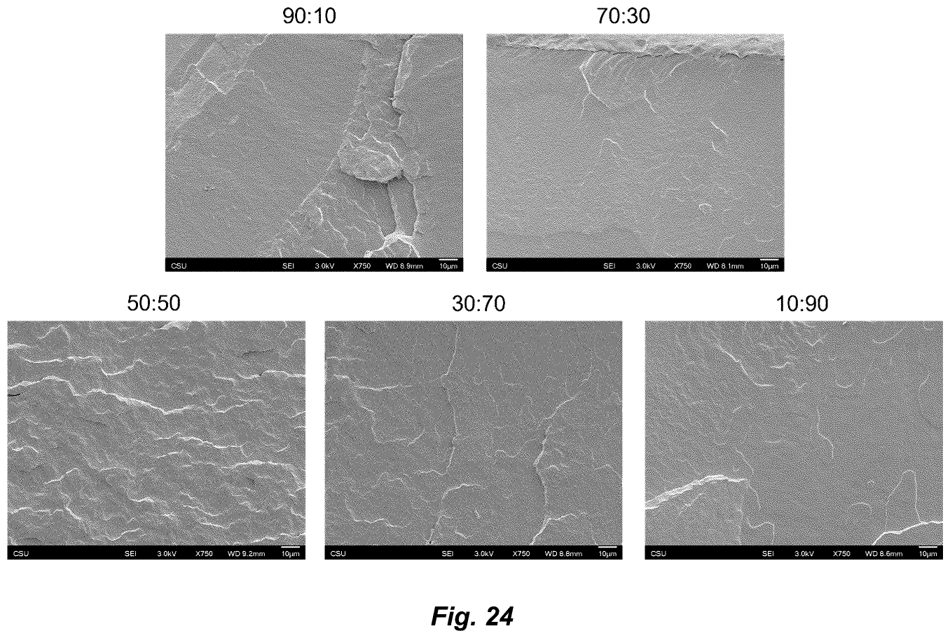

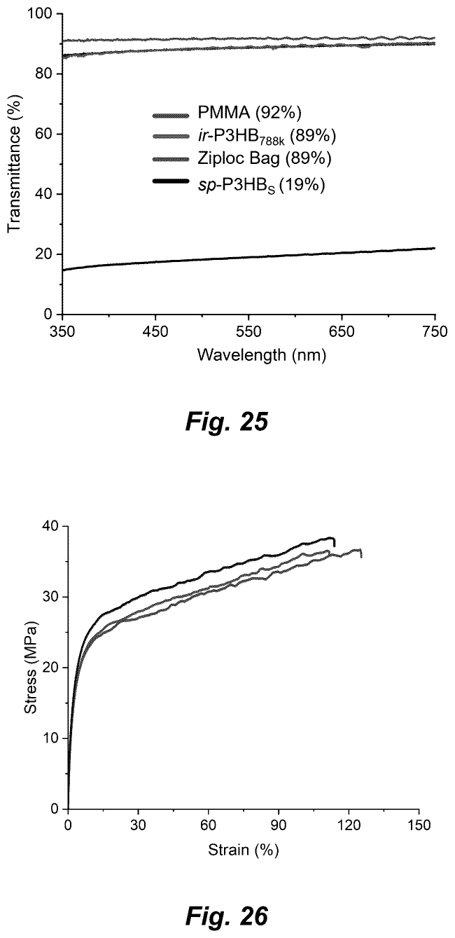

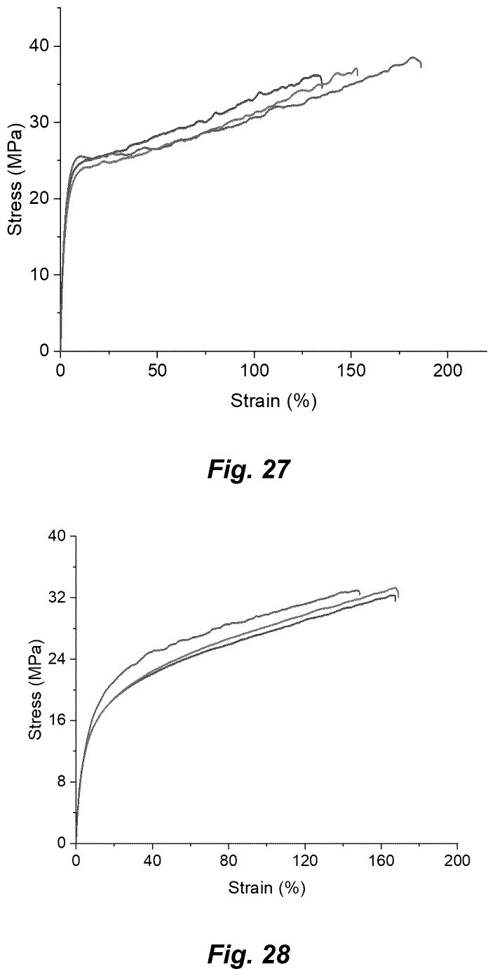

To further confirm the miscibility and homogeneity of b1_{sp(b)/ir}, we performed scanning electron microscopy (SEM) on the blends with various weight ratios from 90:10 to 10:90 and 30 found no phase separation or droplet formation, again indicating the excellent miscibility between sp-P3HB_{b} and ir-P3HB₇₈₈ₖ (FIGS. 17C and 24). PLOM was used to investigate the film morphologies of selected P3HBs. The image of sp-P3HB_{b} showed large spherulites over 200 microns, while the ir-P3HB₇₈₈ₖ was characterized with submicron spherulite texture, indicating a much higher nucleation density. Such a high nucleation density is posited to be caused by the stereodefects present in ir-P3HB₇₇₈ₖ. This dual role of the stereodefects, which disrupt the crystallizable sequences (thus reducing Tₘ and crystallinity) but also provide nucleation sites, is the perfect molecular key to enhanced ductility and improved transparency (large spherulites scatter light, if their size is similar or below 0.4 microns, the material becomes transparent).²⁰ Indeed, because of the increased nucleation density and, thereby the absence of large spherulites, optical analysis showed that ir-P3HB₇₈₈ₖ displayed a significantly improved transmittance to 89% relative to sp-P3HB (19%) (FIG. 25). Consistent with SSA and SEM studies, the PLOM image of b1_{sp(b)/ir} exhibited a homogeneous morphology with spherulite sizes in-between those of sp-P3HB_{b} and ir-P3HB₇₇₈ₖ.

Mechanical properties of the newly developed P3HB materials were systematically studied to evaluate the effects of the molar mass, backbone tacticity, and blending paring. As shown in FIG. 18A, sp-P3HBs remains brittle (SB=2.2%) even with an improved Mₙ to 290 kDa. Its pure isotacticity ([mm]>99%) and low nucleation density resulted in high crystallinity (67%) with large spherulites that concentrate stresses in the interspherulitic boundaries leading to crack nucleation and early fracture without significant plastic deformation. Reducing the isotacticity to [mm]=93% slightly enhanced ε_{B} to 7.6% for the corresponding it-P3HB (Table 2.2, Entry 3 vs. 2). Further decreasing the isotacticity to [mm]=80% dramatically improved the ductility to 375% for ir-P3HB₁₀₆ₖ (Mₙ=106 kDa) and to 745% for ir-P3HB₇₈₈ₖ (Mₙ=788 kDa) (Table 2.2, Entries 4-5). In addition to its high ductility, ir-P3HB₇₈₈ₖ also exhibits high tensile strength σ_{B}=29 MPa and good E=700 MPa, leading to a tough material with U_{T}=120 MJ m⁻³, which is >200 times tougher than sp-P3HBs (U_{T}=0.4 MJ m⁻³). The sr-P3HB, produced from meso-8DL^{Me} with a low Pₘ value of 0.29 (no mm triad) and Mₙ=260 kDa, was found to be a softer (E=85 MPa, SB=803%) but tougher (U_{T}=135 MJ m⁻³) material (FIG. 18A; Table 2.2, Entry 6). Noteworthy here is that the ir-P3HB_{BBL} (Pₘ=0.86, Mₙ=224 kDa) synthesized from rac-BBL is much inferior to that of ir-P3HB produced from rac-8DL^{Me}, showing a decreased ε_{b} and σ_{B} by 36% and 48%, respectively (FIG. 18A; Table 2.2, Entry 7), which is again likely caused the heterogeneity of ir-P3HB_{BBL} arising from the less controlled polymerization of rac-BBL and the intrinsic microstructural differences between the two ir-P3HBs (vide supra).

TABLE 2.2
Thermal and mechanical properties of stereomicrostructurally engineered P3HBs and blends ^{a}

| | | Tₘ | ΔH_{f} | T_{c} | ΔH_{c} | T_{g} | X_{c} | σ_{y} | σ_{B} | E | ε_{B} | U_{T} |
|---|---|---|---|---|---|---|---|---|---|---|---|---|
| Entry | P3HB | (° C.) | (J g⁻¹) | (° C.) | (J g⁻¹) | (° C.) | (%) | (MPa) | (MPa) | (GPa) | (%) | (MJ m⁻³) |
| 1 | sp-P3HB_{b} | 175 | 99.9 | 124 | 89.6 | 9 | 68 | n.a. | 32.0 | 2.7 | 5.5 | 1.1 |
| 2 | sp-P3HBₛ | 172 | 97.5 | 97 | 87.2 | 8 | 67 | n.a. | 28.6 | 3.7 | 2.2 | 0.4 |
| 3 | it-P3HB | 155 | 66.0 | 81 | 61.8 | 7 | 45 | n.a. | 33.5 | 2.0 | 7.6 | 2.0 |
| 4 | ir-P3HB₁₀₆ₖ | 108* | 26.8 | n.a. | n.a. | 4 | 18 | 19.7 | 22.2 | 0.8 | 375 | 60.4 |
| 5 | ir-P3HB₇₈₈ₖ | 108* | 25.4 | n.a. | n.a. | 5 | 17 | 15.7 | 28.9 | 0.7 | 745 | 120 |
| 6 | sr-P3HB | 66* | 32.1 | n.a. | n.a. | 6 | 22 | 7.1 | 31.3 | 0.1 | 803 | 135 |
| 7 | ir-P3HB_{BBL} | 151 | 54.4 | 63 | 39.4 | 4 | 37 | 14.6 | 11.5 | 0.9 | 240 | 25.7 |
| 8 | bl_{sp(s)/ir} | 170 | 58.4 | 92 | 56.2 | 7 | 40 | 26.4 | 37.7 | 1.7 | 213 | 62.7 |
| 9 | bl_{sp(b)/ir} | 163 | 53.2 | 120 | 52.7 | 8 | 36 | n.a. | 37.3 | 1.3 | 158 | 47.0 |
| 10 | bl_{sp(b)/ir(BBL)} | 169 | 70.5 | 119 | 63.3 | 8 | 48 | 30.6 | 28.7 | 2.2 | 21 | 5.9 |
| 11 | bl_{sp(b)/sr} | 169 | 74.6 | 116 | 66.8 | 6 | 51 | n.a. | 36.6 | 0.4 | 188 | 56.3 |
| 12 | bl_{sp(b)/at} | 170 | 65.7 | 121 | 58.8 | 6 | 45 | n.a. | 22.6 | 0.5 | 56 | 10.5 |

^{a} Molar mass and tacticity information can be found in Table 2.1. See Supporting Information below for abbreviations and experimental details.
*Data collected from the first heating scan, while all others from the second heating scan. n.a. = not applicable.

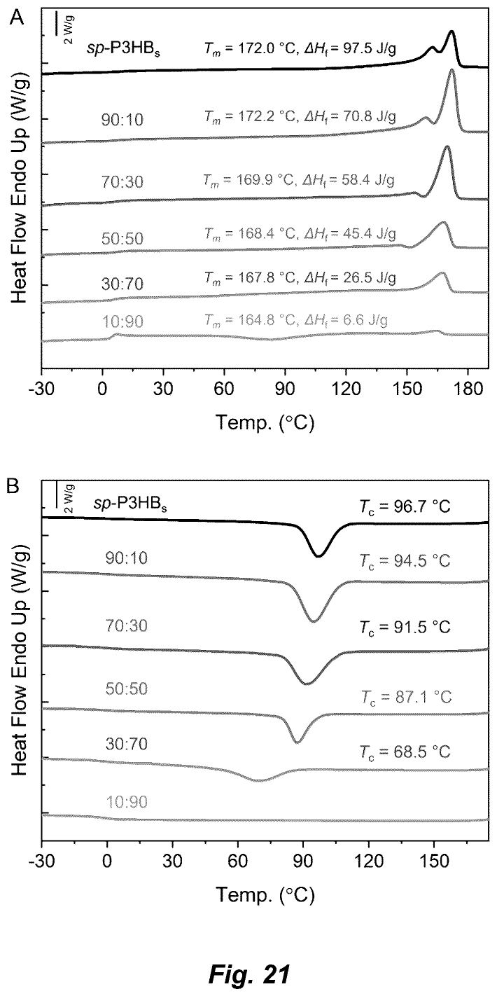

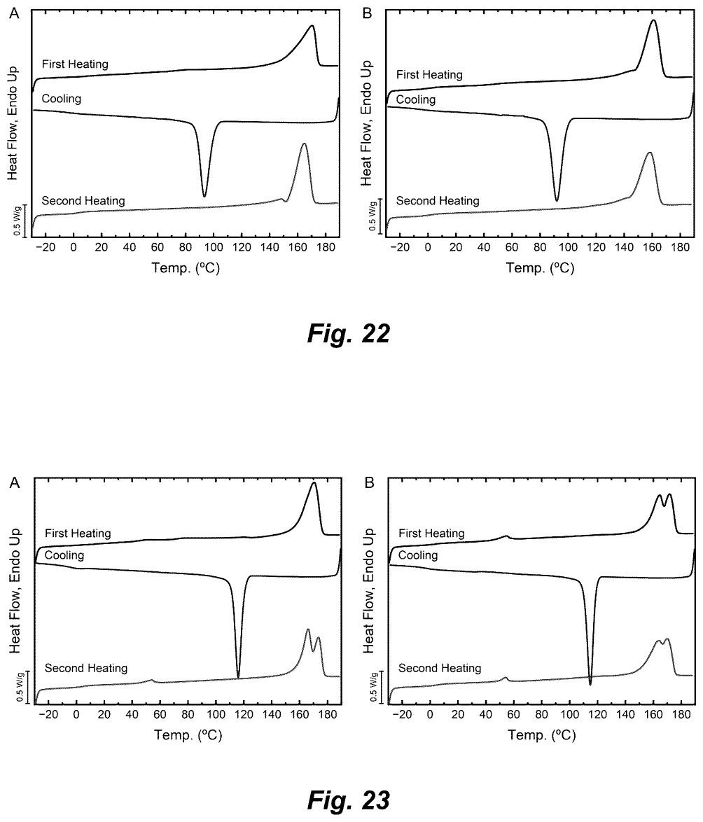

Compared to the brittle sp-P3HB, the stereomicrostructurally engineered P3HB s displayed substantially improved ductility and toughness. However, elastic modulus, yield stress, and Tₘ were significantly lowered. To overcome these property trade-offs, we blended the brittle sp-P3HB with the ductile ir-P3HB₇₈₈ₖ in weight ratios from 90:10 to 10:90, five total decreasing by 20% each. Excitingly, all b1_{sp(s)/ir} blends displayed a high Tₘ (>160° C.), which is lower than sp-P3HB (a fact caused by the blend miscibility) but much higher than that of ir-P3HB₇₈₈ₖ (FIGS. 17A, 21; Table 2.2).

Synergistically, ir-P3HB₇₈₈ₖ toughened sp-P3HBs by displaying dramatically improved ductility and toughness in all studied ratios (FIG. 18B): with the increase of sp-P3HBs content, the blend displayed gradually enhanced Cy from 14 MPa to 37 MPa and E from 0.8 GPa to 2.7 GPa, which are approaching that of sp-P3HBs (˜30 MPa and 3.7 GPa), as well as significantly improved ductility (95-450%). This synergistic toughening methodology also applies to sp-P3HB_{b}, demonstrated by the greatly improved mechanical performance with E=1.3 GPa, ε_{b}=158%, and U_{T}=47 MJ m⁻³ for b1_{sp(b)/ir} (70:30 ratio; FIG. 18C; Table 2.2, Entry 9). Extending the blending of sp-P3HB_{b} with ir-P3HB₁₇₇ₖ with lower molar mass (Mₙ=177 kDa) achieved comparable mechanical properties with E=1.1 GPa, ε_{b}=123%, and U_{T}=38 MJ m⁻³ (FIG. 26), showing the versatility and good compatibility of this blending method. In contrast, b1_{sp(b)/ir(BBL)}, the blend of sp-P3HB_{b} and ir-P3HB_{BBL} with similar molar mass, appeared still to be brittle with ε_{b}=21% and U_{T}=6 MJ m⁻³ (FIG. 18C; Table 2.2, Entry 10), which is likely again caused by the heterogeneity and distinct microstructures of ir-P3HB_{BBL}.

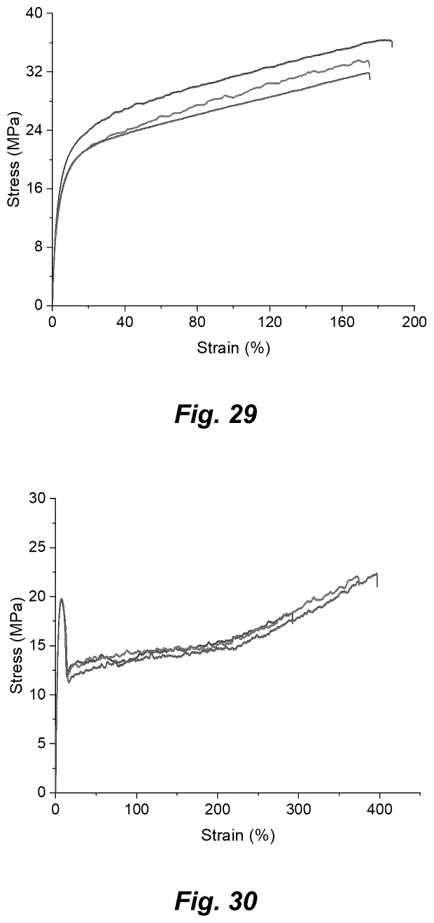

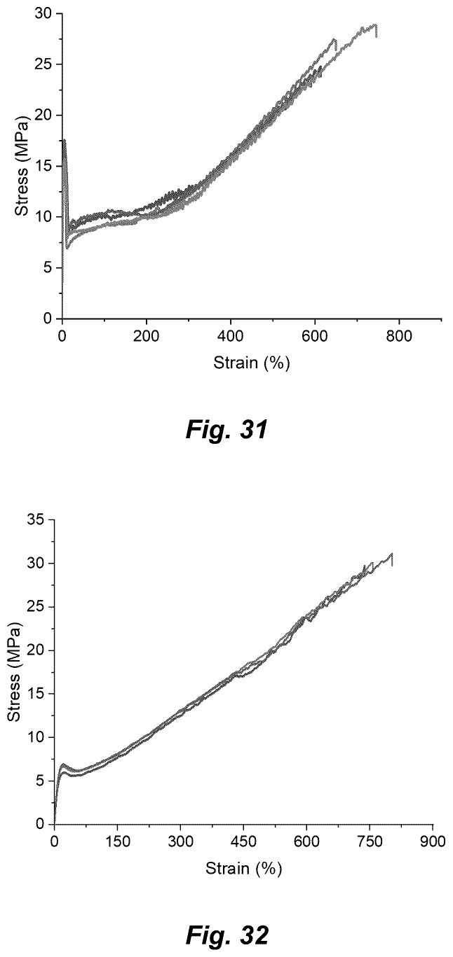

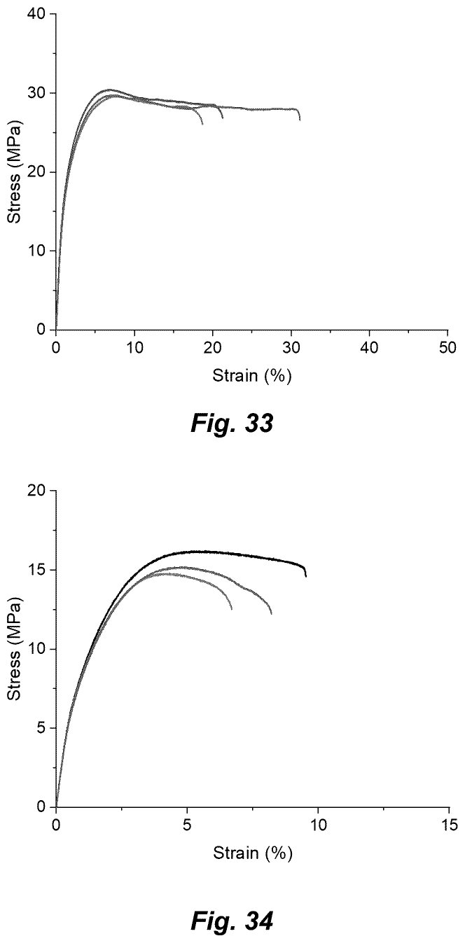

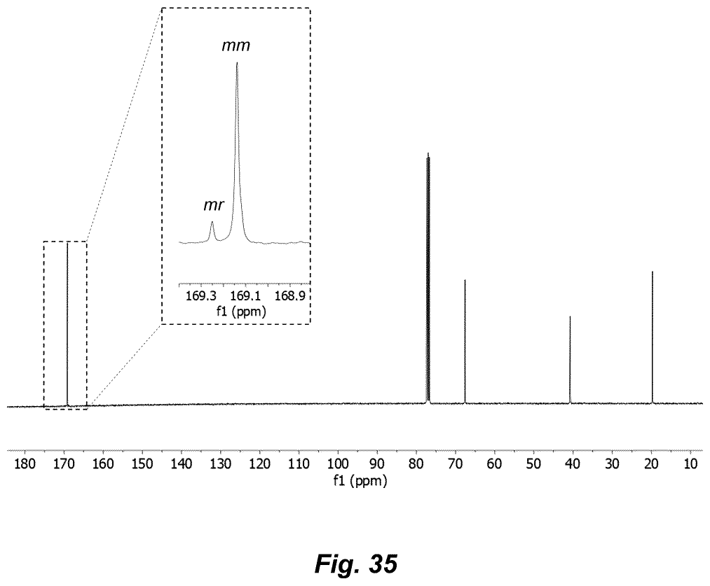

To further extend to other P3HB stereomicrostructures, we blended sp-P3HB_{b} with sr-P3HB (b1_{sp(b)/sr}) and at-P3HB (b1_{sp(b)/at}) in the same weight ratio of 70:30 and found that the semicrystalline sr-P3HB worked similarly to ir-P3HB₇₈₈ₖ, achieving a comparable σ_{B} and U_{T} for b1_{sp(b)/sr} (FIG. 18C; Table 2.2, Entry 11). However, the amorphous at-P3HB only slightly toughened sp-P3HB_{b} and showed a dramatically decreased ductility and tensile stress vs. b1_{sp(b)/sr} (FIG. 18C; Table 2.2, Entry 12). These observations could be explained by the fact that the crystalline domains of ir- and sr-P3HBs co-crystallize with the highly crystalline sp-P3HB_{b}, while the amorphous at-P3HB only contributes to the amorphous domains. To probe the morphological stability, sp-P3HB blends with ir- and sr-P3HBs were subjected to the annealing process at ˜25° C. for 12 h and subsequently subjected to tensile re-testing. The results showed no deterioration in mechanical performance for the annealed samples (FIG. 29), indicating a morphologically stable blend, which is attributed to the identical chemical structures among P3HBs and high miscibility.

In summary, the 8DL^{Me} platform allowed expedient access to high-molar-mass (Mₙ to 788 kDa) P3HB materials with an entire spectrum of stereomicrostructures ([mm] from 0 to 100%), high ductility to ˜800%, and high toughness to 135 MJ m⁻³ (>120× tougher than bio-P3HB). Such high-performance P3HBs also drastically toughen brittle stereoperfect bio- or synthetic P3HB (up to 156×), while largely maintaining its otherwise desirably high elastic modulus (>1 GPa), tensile strength (>35 MPa), and melting temperature (>160° C.). Overall, the advancements presented here offer a versatile toolbox to tailor thermomechanical properties of P3HB, while adhering to the mono-material product design principle solely based on biodegradable P3HB.

### Citations for Example 2.

(1) Westlie, Quinn, Parker, and Chen, Synthetic biodegradable polyhydroxyalkanoates (PHAs): Recent advances and future challenges. Prog. Polym. Sci. 2022, 134, 101608.
(2) Bedade, D. K.; Edson, C. B.; Gross, R. A., Emergent approaches to efficient and sustainable polyhydroxyalkanoate production. Molecules 2021, 26, 3463.
(3) Koller, M., The Handbook of Polyhydroxyalkanoates: Kinetics, Bioengineering, and Industrial Aspects. CRC Press: 2020.
(4) Raza, Z. A.; Abid, S.; Banat, I. M., Polyhydroxyalkanoates: Characteristics, production, recent developments and applications. Int biodeterior. biodegrad. 2018, 126, 45-56.
(5) Taguchi et al., Poly(hydroxyalkanoate)s. In Poly(hydroxyalkanoates)s in Polymer Science: A Comprehensive Reference; Matyjaszewski and Moller, Eds.; Elsevier: Amsterdam, 2012, pp 157-182.
(6) Chen, G.-Q., A microbial polyhydroxyalkanoates (PHA) based bio-and materials industry. Chem. Soc. Rev. 2009, 38 (8), 2434-2446.
(7) Sudesh, K.; Abe, H.; Doi, Y., Synthesis, structure and properties of polyhydroxyalkanoates: biological polyesters. Prog. Polym. Sci. 2000, 25, 1503-1555.
(8) Milner, H. M.; Seebach, D., Poly (hydroxyalkanoates): a fifth class of physiologically important organic biopolymers? Angew. Chem. Int. Ed. 1993, 32, 477-502.
(9) Anjum, A.; Zuber, M.; Zia, K. M.; Noreen, A.; Anjum, M. N.; Tabasum, S., Microbial production of polyhydroxyalkanoates (PHAs) and its copolymers: a review of recent advancements. Int. J. Biol. Macromot 2016, 89, 161-174.
(10) Laycock, B.; Halley, P.; Pratt, S.; Werker, A.; Lant, P., The chemomechanical properties of microbial polyhydroxyalkanoates. Prog. Polym. Sci. 2013, 38, 536-583.
(11) Muhammadi; Shabina; Afzal, M.; Hameed, S., Bacterial polyhydroxyalkanoates-eco-friendly next generation plastic: production, biocompatibility, biodegradation, physical properties and applications. Green Chem. Lett. Rev. 2015, 8, 56-77.
(12) Sangroniz, A.; Zhu, J.-B.; Tang, X.; Etxeberria, A.; Chen, E. Y.-X.; Sardon, H., Packaging materials with desired mechanical and barrier properties and full chemical recyclability. Nat. Commun. 2019, 10, 3559.
(13) Li, H.; Shakaroun, R. M.; Guillaume, S. M.; Carpentier, J. F., Recent advances in metal-mediated stereoselective ring-opening polymerization of functional cyclic esters towards well-defined poly (hydroxy acid) s: from stereoselectivity to sequence-control. Eur. J. Chem. 2020, 26, 128-138.
(14) Adamus, G.; Domiński, A.; Kowalczuk, M.; Kurcok, P.; Radecka, I., From anionic ring-opening polymerization of β-butyrolactone to biodegradable poly(hydroxyalkanoate) s: our contributions in this field. Polymers 2021, 13, 4365.
(15) Inoue, S.; Tomoi, Y.; Tsuruta, T.; Furukawa, J., Organometallic-catalyzed polymerization of propiolactone. Makromol. Chem. 1961, 48, 229-233.
(16) Tang, X.; Chen, E. Y.-X., Toward infinitely recyclable plastics derived from renewable cyclic esters. Chem 2019, 5, 284-312.
(17) Bruckmoser, J.; Pongratz, S.; Stieglitz, L.; Rieger, B., Highly Isoselective Ring-Opening Polymerization of rac-β-Butyrolactone: Access to Synthetic Poly(3-hydroxybutyrate) with Polyolefin-like Material Properties. J. Am. Chem. Soc. 2023, 145, 11494-11498.
(18) Zintl et al., Variably Isotactic Poly(hydroxybutyrate) from Racemic β-Butyrolactone: Microstructure Control by Achiral Chromium (III) Salophen Complexes. Angew. Chem. Int. Ed. 2008, 47, 3458-3460.
(19) Tang, X.; Chen, E. Y.-X., Chemical synthesis of perfectly isotactic and high melting bacterial poly(3-hydroxybutyrate) from bio-sourced racemic cyclic diolide. Nat. Commun. 2018, 9, 2345.
(20) Quinn, E. C.; Westlie, A. H.; Sangroniz, A.; Caputo, M. R.; Xu, S.; Zhang, Z.; Urgun-Demirtas, M.; Müller, A. J.; Chen, E. Y.-X., Installing Controlled Stereo-Defects Yields Semicrystalline and Biodegradable Poly(3-Hydroxybutyrate) with High Toughness and Optical Clarity. J. Am. Chem. Soc. 2023, 145, 5795-5802.
(21) Li et al., Recyclable polyhydroxyalkanoates via a regioselective ring-opening polymerization of α, β-disubstituted β-lactone monomers. Macromolecules 2021, 54, 4641-4648.
(22) Tang, X.; Westlie, A. H.; Watson, E. M.; Chen, E. Y.-X., Stereosequenced crystalline polyhydroxyalkanoates from diastereomeric monomer mixtures. Science 2019, 366, 754-758.
(23) Zhang, Z.; Shi, C.; Scoti, M.; Tang, X.; Chen, E. Y.-X., Alternating Isotactic Polyhydroxyalkanoates via Site-and Stereoselective Polymerization of Unsymmetrical Diolides. J. Am. Chem. Soc. 2022, 144, 20016-20024.
(24) Kramer et al., Polymerization of enantiopure monomers using syndiospecific catalysts: a new approach to sequence control in polymer synthesis. J. Am. Chem. Soc. 2009, 131, 16042-16044.
(25) Zhou, Z.; LaPointe, A. M.; Shaffer, T. D.; Coates, G. W., Nature-inspired methylated polyhydroxybutyrates from C1 and C4 feedstocks. Nat. Chem. 2023, 15, 856-861.
(26) Abe at al., Physical properties and enzymic degradability of poly(3-hydroxybutyrate) stereoisomers with different stereoregularities. Macromolecules 1994, 27, 6018-6025.
(27) Ebrahimi, T.; Aluthge, D. C.; Hatzikiriakos, S. G.; Mehrkhodavandi, P., Highly active chiral zinc catalysts for immortal polymerization of β-butyrolactone form melt processable syndio-rich poly(hydroxybutyrate). Macromolecules 2016, 49, 8812-8824.
(28) Tang, Shi, Zhang, and Chen, Toughening biodegradable isotactic poly(3-hydroxybutyrate) via stereoselective copolymerization of a diolide and lactones. Macromolecules 2021, 54, 9401-9409.
(29) Tang, X.; Westlie, A. H.; Caporaso, L.; Cavallo, L.; Falivene, L.; Chen, E. Y.-X., Biodegradable Polyhydroxyalkanoates by Stereoselective Copolymerization of Racemic Diolides: Stereocontrol and Polyolefin-Like Properties. Angew. Chem. Int. Ed. 2020, 132, 7955-7964.
(30) Dufresne, A.; Vincendon, M., Poly(3-hydroxybutyrate) and poly(3-hydroxyoctanoate) blends: morphology and mechanical behavior. Macromolecules 2000, 33, 2998-3008.
(31) Hou et al., Tailoring Crystalline Morphology via Entropy-Driven Miscibility: Toward Ultratough, Biodegradable, and Durable Polyhydroxybutyrate. Macromolecules 2022, 55, 5527-5534.
(32) Li, Z.; Yang, J.; Loh, X. J., Polyhydroxyalkanoates: opening doors for a sustainable future. NPG Asia Mater. 2016, 8, e265-e265.
(33) Popa, M. S.; Frone, A. N.; Panaitescu, D. M., Polyhydroxybutyrate blends: A solution for biodegradable packaging? Int. J. Biol. Macromol. 2022, 207, 263-277.
(34) Quinn, E. C.; Knauer, K. M.; Beckham, G. T.; Chen, E. Y.-X., Mono-material product design with bio-based, circular, and biodegradable polymers. One Earth 2023, 6, 582-586.

### Supporting Information for Example 2.

Materials and General Methods. All synthesis and manipulations requiring dry inert atmosphere were performed under a nitrogen atmosphere using standard Schlenk techniques or in a N₂ or Ar-supplied glovebox. HPLC-grade organic solvents were first sparged extensively with nitrogen during filling 20 L solvent reservoirs and then dried by passage through activated alumina (for dichloromethane, DCM) followed by passage through Q-5 supported copper catalyst (for toluene and hexanes) stainless steel columns. Benzyl alcohol (BnOH) was purchased from Alfa Aesar Chemical Co., purified by distillation over CaH2, and stored over activated Davison 4 A molecular sieves. Dimethyl succinate, sodium methoxide, and 3-chloroperoxybenzoic acid (m-CPBA, 70-75%) were purchased from Fisher Scientific Co. and used as received. Iodomethane was purchased from Alfa Aesar Chemical Co. and used as received. Poly(methyl methacrylate) (PMMA, powder, Mₙ=120 kDa, 182230) was purchased from Sigma-Aldrich. Biological poly(3-hydroxybutyrate) (P3HB) (AA=550 kg/mol) was purchased from Goodfellow. For the blending studies, the purchased biological P3HB was dissolved in chloroform, precipitated into methanol, and then dried in a vacuum oven at 60° C. for 24 h to a constant weight. Its absolute molar mass and distribution were measured in house by size exclusion chromatography (SEC) coupled with light scattering detection to exhibit Mₙ=379 kDa, Ð=2.02, and it was designated as sp-P3HB_{b} for this study. Rac-, meso-8DL^{Me}, and the yttrium complexes used in this study were synthesized according to reported procedures.¹⁻²

General Polymerization Procedures. Polymerizations were performed inside a N₂-filled glovebox at a predetermined temperature. The reactor was charged with a specific amount of monomer and solvent (as specified in the polymerization tables) in the glovebox, and a mixture of catalyst and initiator in a solvent was stirred at ambient temperature (˜25° C.) for 10 min in another reactor. The polymerization was initiated by rapid addition of the catalyst solution to the monomer solution. After a desired time period, the polymerization was immediately quenched by addition of 0.5 mL of benzoic acid/chloroform (10 mg/mL) and a 0.02 mL of aliquot was taken from the reaction mixture and prepared for ¹H NMR analysis to obtain the percent monomer conversion data. The quenched mixture was then precipitated into 50 mL of cold methanol while stirring, filtered, washed with cold methanol to remove any unreacted monomer, and dried in a vacuum oven at 60° C. for 24 h to a constant weight.

Preparation of physical blends of sp-P3HB and stereomicrostructurally engineered P3HBs via Solution Processes. sp-P3HBs (Mₙ=290 kDa, Ð=1.02) or sp-P3HB_{b} (Mₙ=379 kDa, Ð=2.02) were mixed with stereomicrostructurally engineered P3HBs in a predetermined weight ratio and were dissolved in chloroform (˜45 mg/mL). After refluxing for 2 h, the mixture was precipitated into methanol (200 mL) while stirring. After filtration, the resulting polymer blend was dried in a vacuum oven at 60° C. for 24 h to a constant weight. Melt-extrusion Procedures. Melt-extrusion processing of blends was conducted using a

Thermo Fisher Scientific HAAKE Minilab 3 Micro-Compounder (Twin Screw Extruder) in a manual mode. The compounder was operated at 165° C. with inert gas (N₂) flowing through the chamber. The screw was set to 250 rpm, ensuring that torque was not above 5 Nm. The P3HB materials were then added and pushed down to the barrel. The compounder was set to flush mode, and materials directly extruded through over ˜3 minutes. The process was repeated once to ensure good mixing.

Absolute Molecular Weight Measurements. Measurements of polymer absolute weight-average molar mass (M_{w}), number-average molar lass (Mₙ), and molecular weight dispersity (Ð=M_{w}/Mₙ) were performed via SEC. The SEC instrument consisted of an Agilent HPLC system equipped with one guard column and three PLgel 5μm mixed-C gel permeation columns unless indicated otherwise and coupled with a Wyatt DAWN HELEOS II multi (18)-angle light scattering detector and a Wyatt Optilab TrEX dRI detector; the analysis was performed at 40° C. using chloroform as the eluent at a flow rate of 1.0 mL/min, using Wyatt ASTRA 7.1.2 molecular weight characterization software. The refractive index increment (dn/dc) of P3HB was previously determined as 0.0254±0.0004 mL/g.¹

Spectroscopic Characterizations. NMR spectra were recorded on a Varian Inova or Bruker AV-III 400 MHz spectrometer (400 MHz, 1 H; 100 MHz, ¹³C). Chemical shifts for ¹H and ¹³C spectra were referenced to internal solvent resonances and are reported as parts per million relative to CHCl₃.

Thermal Analysis. Melting transition temperature (Tₘ), crystallization temperature (T_{c}), and glass transition temperature (T_{g}) were measured by differential scanning calorimetry (DSC) on an Auto Q20, TA Instrument. All Tₘ and T_{g} values were obtained from the second scan unless noted otherwise. Both heating and cooling rates were 10° C./min. Decomposition temperatures (4 defined by the temperature of 5% weight loss) was measured by thermal gravimetric analysis (TGA) on a Q50 TGA Analyzer, TA Instrument. Polymer samples were heated from ambient temperature to 700° C. at a heating rate of 10° C./min. Values of Tₘₐₓ were obtained from derivative (wt %/° C.) vs. temperature (° C.) plots.

UV-Vis-NIR Optical Property Measurements. A Cary 5000 UV-vis NIR spectrophotometer from Agilent was used to measure the optical properties of thin films that were acquired by solvent casting from a suitable solvent. The films were cast in circular polypropylene petri dishes with a diameter of 4 in. Film thickness was measured to be 0.02+/−0.01 mm. Films were acquired by solvent casting from an appropriate solvent which was allowed to evaporate overnight, covered by aluminum foil to allow for slow evaporation, before testing.

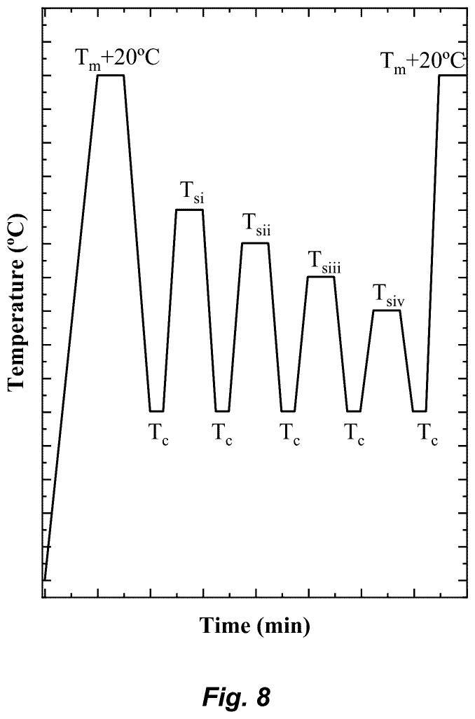

Successive Self-nucleation and Annealing (SSA). SSA is a thermal fractionation technique that is performed using a DSC to study the different molecular segregation capacities that semicrystalline polymers can exhibit after isothermal crystallization and annealing processes.³ SSA thermal fractionation is promoted by any defect interrupting linear crystallizable sequences, like stereodefects, branching or presence of comonomers. The many different purposes of the SSA technique are amply shown and described by Perez-Camargo et al.⁴ The SSA experiments were carried out following the protocol defined by Muller et al.^{3,5} and are summarized in FIG. 8.

The first heating scan is the one in which the thermal history of the sample is erased (heating the sample 20° C. above the melting temperature and keeping it at that temperature for 1 min in the case of PHBs to avoid any degradation influence). For this work, during the second step, the samples were cooled down to −30° C. After 1 min at this temperature, the sample was heated to a temperature of 7.5° C. lower than the end-temperature melting (as a proxy of the ideal self-nucleation temperature, which is normally obtained by self-nucleation studies, which are difficult to perform in PHB due to its possible degradation) and kept for 3 min at that temperature. Subsequently, the sample was cooled again to −30° C. and held at this temperature for 1 min. This cyclic process was repeated by varying the Ts', decreasing it at each cycle by 7.5° C. until all the material melting range has been covered. Finally, the sample was heated to the molten state (20° C. above Tₘ) to observe the results of the SSA thermal fractionation, reported in FIG. 17B.

For ir-P3HB_{BBL}, a similar method was used but the sample was heated to a temperature of 7.5° C. lower than the temperature used to remove thermal history (20° C. above the Tₘ) for ten successive rounds. All scans for the sample sp-P3HB_{b} were performed at 20° C./min, instead, for the samples ir-P3HB and b1_{sp(B)/ir}, the cooling rates were 1° C./min (to promote crystallization during cooling) and the heating rates at 20° C./min, using a Perkin Elmer DSC 8000 with an Intracooler II as a cooling system. This equipment was calibrated using indium and tin as standards. For comparative purposes, this experiment was also performed on biological sp-PHB_{b} Goodfellow).

Mechanical Analysis. Tensile stress/strain testing was performed by an Instron 5966 universal testing system (10 kN load cell) on dog-bone-shaped test specimens (ASTM D638 standard; Type V) prepared via compression molding using a Carver Bench Top Laboratory Press (Model 4386) equipped with a two-column hydraulic unit (Carver, Model 3912, maximum force 24000 psi) unless indicated otherwise. Isolated polymer materials were loaded between non-stick Teflon paper sheets into a stainless-steel mold with inset dimensions 30×73.5×0.38 mm fabricated inhouse and compressed between two 6″×6″ steel electrically heated platens (EHP) clamp force 5000 psi, at temperature of each material's respective Tₘ. Specimens for analysis were generated via compression molding and cut using an ASTM D638-5-IMP cutting die (Qualitest) to standard dimensions. Mechanical behavior was averaged for all the specimens measured for each individual species investigated. Thickness (0.38±0.01 mm), width (3.18 mm), and grip length (26.4±0.2 mm) of the measured dog-bone specimens were measured for normalization of data by the Bluehill measurement software (Instron). Test specimens were affixed into the screw-tight grip frame. Tensile stress and strain were measured to the point of material break at a grip extension speed of 5.0 mm min⁻¹ at ambient conditions.

### Citations for Example 2 Supporting Information.

(1) Tang and Chen, Chemical synthesis of perfectly isotactic and high melting bacterial poly (3-hydroxybutyrate) from bio-sourced racemic cyclic diolide. Nat. Commun. 2018, 9, 1-11.
(2) Tang, Westlie, Watson, and Chen, Stereosequenced Crystalline Polyhydroxyalkanoates from Diastereomeric Monomer Mixtures. Science 2019, 366, 754-758.
(3) Muller et al., Successive Self-nucleation and Annealing (SSA): Correct design of thermal protocol and applications. Eur. Polym. J. 2015, 65, 132-154.
(4) Pérez-Camargo et al., Recent applications of the Successive Self-nucleation and Annealing thermal fractionation technique. Front. Soft Matter 2022, 13.
(5) Müller and Arnal, Thermal fractionation of polymers. Prog. Polym. Sci. 2005, 30, 559-603.

### Example 3. Polymerization of meso-8DL^{Me} to st-P3HB and Characterization Data

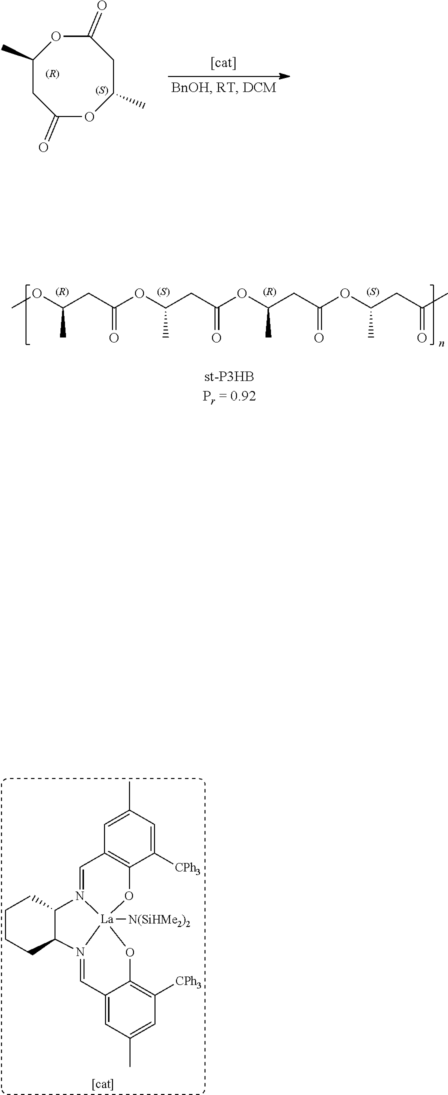

TABLE 3.1
Polymerization of meso-8DL^{Me} to st-P3HB.

| | Time | Conversion | Mₙ | |
|---|---|---|---|---|
| [monomer]:[La]:[BnOH] | (min) | (%) | (kDa) | Ð |
| 150:1:0.25 | 645 | 74 | 67.1 | 1.05 |

Conditions: meso-8DL^{Me} = 1,500 mg (8.7 mmol); [meso-8DL^{Me}] = 1.00M; DCM as the solvent, Vₛₒₗᵥₑₙₜ = 8.7 mL; room temperature (~25° C.).

TABLE 3.2
Stress-strain data of sr-P3HB.

| Sample Number | σ_{B} (MPa) | ε_{B} (%) | E (MPa) |
|---|---|---|---|
| 1 | 33.0 | 444.2 | 205 |
| 2 | 34.6 | 388.94 | 108 |
| 3 | 31.1 | 394.38 | 216 |
| Average | 33 ± 1.4 | 409 ± 25 | 176 ± 49 |

Conditions: meso-8DL^{Me}:La[N(SiMe₃)₂:Ph₂CHOH = 5000:1:3 (Mₙ = 171 kDa, Ð = 1.07).

TABLE 3.3
Rate constants, estimation of end of life, and the
R square values of Fresh Water (FW) and soil biodegradation
of sr-P3HB, (R)-P3HB, and bio-P3HB.

| | | Estimated 90% | |
|---|---|---|---|
| | Rate constant | biodegradation | |
| | (day⁻¹) | (day) | R² |
| sr-P3HB, FW | 0.0050 | 383 | 0.8256 |
| (R)-P3HB, FW | 0.0049 | 433 | 0.9163 |
| bio-P3HB, FW | 0.0079 | 282 | 0.9894 |
| sr-P3HB, soil | 0.0092 | 268 | 0.9520 |
| (R)-P3HB, soil | 0.0179 | 145 | 0.9642 |
| bio-P3HB, soil | 0.0273 | 105 | 0.9381 |

While specific embodiments have been described above with reference to the disclosed embodiments and examples, such embodiments are only illustrative and do not limit the scope of the invention. Changes and modifications can be made in accordance with ordinary skill in the art without departing from the invention in its broader aspects as defined in the following claims.

All publications, patents, and patent documents are incorporated by reference herein, as though individually incorporated by reference. No limitations inconsistent with this disclosure are to be understood therefrom. The invention has been described with reference to various specific and preferred embodiments and techniques. However, it should be understood that many variations and modifications may be made while remaining within the spirit and scope of the invention.

What is claimed is:

1. A polymer comprising a syndio-rich poly(3-hydroxyalkanoate) of formula I, or an iso-rich poly(3-hydroxyalkanoate) of formula II: 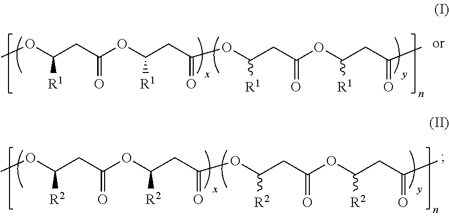
wherein,
R¹ are each (C₁-C₁₈)alkyl, (C₁-C₈)alkenyl, (C₁-C₈)alkynyl, benzyl, or aryl; or
R² are each (C₁-C₁₈)alkyl, (C₁-C₈)alkenyl, (C₁-C₈)alkynyl, benzyl, or aryl;
x are syndiotactic triads (rr) in the polymer of formula I, wherein the syndiotactic triads have at least 95% alternating (R) and (S) stereochemical configurations with respect to the stereocenters of substituents R¹ on the polymer chain;
y are heterotactic triads (mr or rm) in the polymer of formula I, wherein the heterotactic triads have random stereochemical configurations with respect to the stereocenters of substituents R¹ on the polymer chain;
wherein repeat units of y are randomly distributed between repeat units of x throughout the polymer chain; or
x are isotactic triads (mm) in the polymer formula II, wherein the isotactic triads have at least 95% consecutive (R) stereochemical configurations or 95% consecutive (S) stereochemical configurations with respect to the stereocenters of substituents R² on the polymer chain;
y are heterotactic triads (mr or rm) in the polymer of formula II, wherein the heterotactic triads have random stereochemical configurations with respect to the stereocenters of substituents R² on the polymer chain;
wherein repeat units of y are randomly distributed between repeat units of x throughout the polymer chain; and
n is about 10 to about 5,000.

2. The polymer of claim 1 wherein the probability of racemic linkages between two consecutive monomer units (Pᵣ) for formula I is about 0.5 to about 0.95 and/or the mole % of syndiotactic triads (rr) present in formula I is about 25% to about 90%.

3. The polymer of claim 2 wherein the probability of racemic linkages between two consecutive monomer units (Pᵣ) for formula I is about 0.65 to about 0.92 and/or the mole % of syndiotactic triads (rr) present in formula I is about 40% to about 85%.

4. The polymer of claim 1 wherein the probability of meso linkages between monomer units (Pₘ) for formula II is about 0.5 to about 0.95 and/or the mole% of isotactic triads (mm) present in formula II is about 25% to about 90%.

5. The polymer of claim 4 wherein the probability of meso linkages between monomer units (Pₘ) for formula II is about 0.7 to about 0.94 and/or the mole% of isotactic triads (mm) present in formula II is about 50% to about 87%.

6. The polymer of claim 1 wherein each R¹ of formula I is methyl and the polymer is syndio-rich poly(3-hydroxybutyrate) (sr-P3HB).

7. The polymer of claim 1 wherein each R² of formula II is methyl and the polymer is iso-rich poly(3-hydroxybutyrate) (ir-P3HB).

8. A polymer blend comprising a polymer of formula I or formula II of claim 1 and biologically or synthetically produced stereo perfect poly(3-hydroxybutyrate) (sp-P3HB), wherein sp-P3HB is:
a purely isotactic aliphatic polyester having an absolute (R) or (S) stereochemical configuration; or
a purely syndiotactic polyester having an alternating (R) and (S) stereochemical configuration.

9. The polymer blend of claim 8 wherein the weight% ratio of a polymer of formula I to sp-P3HB or a polymer of formula II to sp-P3HB is about 1:9 to about 9:1; or
wherein the wt. % ratio is about 1:9 to about 1:1.

10. The polymer blend of claim 8 wherein the polymer blend has an optical clarity above about 50% visible light transmittance.

11. A method for a ring opening polymerization (ROP) reaction for preparing a polymer according to claim 1, the method comprising: contacting i) an effective amount of a metal catalyst; ii) an alcohol initiator, wherein the alcohol initiator is P₂CHOH, PhCH₂OH, or P₃COH; and iii) a monomer of formula III, or a racemic mixture of a monomer of formula IV and a monomer of formula V: 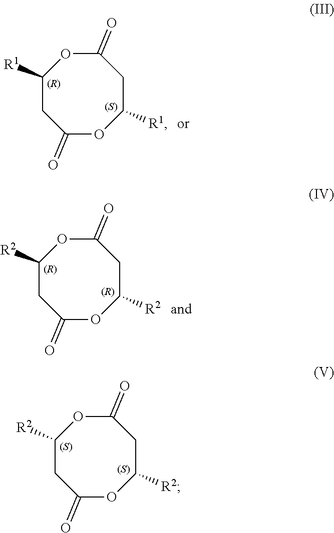
wherein,
R¹ are each (C₁-C₁₈)alkyl, (C₁-C₈)alkenyl, (C₁-C₈)alkynyl, benzyl, or aryl; or
R² are each (C₁-C₁₈)alkyl, (C₁-C₈)alkenyl, (C₁-C₈)alkynyl, benzyl, or aryl; and
the metal catalyst is La[N(Si(CH₃)₃)₂]₃; or the metal catalyst is a metal complex of formula VI: 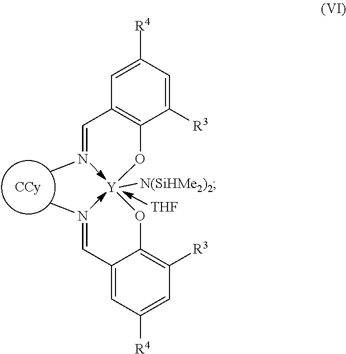
wherein,
CCy is A or B: 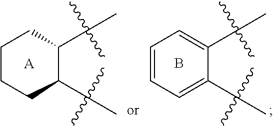
each R³ is tent-butyl, CP₃, or C(CH₃)₂Ph; and
each R⁴ is tent-butyl, CH₃, or C(CH₃)₂Ph;
wherein a syndio-rich poly(3-hydroxyalkanoate) or an iso-rich poly(3-hydroxyalkanoate) is thereby formed.

12. The method of claim 11 wherein each R¹ of formula III is methyl, or each R² of formula IV or formula V is methyl.

13. The method of claim 11 wherein the monomer of formula III is me so-8DL^{Me}:

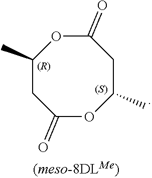

14. The method of claim 13 wherein the metal catalyst is La[N(Si(CH₃)₃)₂]₃; or
wherein the metal catalyst is a complex of formula VI wherein CCy is A, and each R³ and R⁴ is tent-butyl.

15. The method of claim 14 wherein the syndio-rich poly(3-hydroxyalkanoate) formed is syndio-rich poly(3-hydroxybutyrate) (sr-P3HB), wherein the probability of racemic linkages between two consecutive monomer units (Pᵣ) is about 0.65 to about 0.92 and/or the mole % of syndiotactic triads (rr) present is about 40% to about 85%.

16. The method of claim 11 wherein the monomer of formula IV and the monomer of formula V in a racemic mixture is rac-8DL^{Me}:

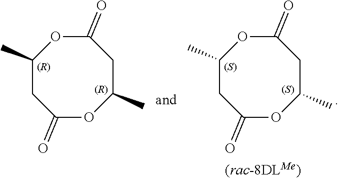

17. The method of claim 16 wherein the metal catalyst is a complex of formula VI wherein CCy is B and each R³ and R⁴ is tent-butyl.

18. The method of claim 17 wherein the iso-rich poly(3-hydroxyalkanoate) formed is iso-rich poly(3-hydroxybutyrate) (ir-P3HB), wherein the probability of meso linkages between monomer units (Pₘ) is about 0.7 to about 0.94 and/or the mole % of isotactic triads (mm) present is about 50% to about 87%.

19. The method of claim 11 further comprising blending the polymer and biologically or synthetically produced stereo perfect poly(3-hydroxybutyrate) (sp-P3HB), wherein sp-P3HB is a purely isotactic aliphatic polyester with an absolute (R) stereochemical configuration or an absolute (S) stereochemical configuration; or
a purely syndiotactic polyester with an alternating (R) and (S) stereochemical configuration;
wherein the weight % ratio of the polymer to sp-P3HB is about 1:9 to about 9:1.

20. An adhesive polymer comprising a polymer according to claim 1, wherein the adhesive polymer adheres to aluminum, steel, glass, or wood at an adhesion strength of about 4 MPa or greater.
